(19) United States
(12) Patent Application Publication
(10) Pub. No.: US 2025/0323247 A1
(43) Pub. Date: Oct. 16, 2025

(54) NEGATIVE ELECTRODE FOR SECONDARY BATTERY AND SECONDARY BATTERY

(71) Applicant: MURATA MANUFACTURING CO., LTD., Kyoto (JP)

(72) Inventors: Yohei SHIMADA, Kyoto (JP); Keitaro KITADA, Kyoto (JP); Yosuke HOSOYA, Kyoto (JP)

(21) Appl. No.: 19/076,266

(22) Filed: Mar. 11, 2025

(30) Foreign Application Priority Data
Apr. 10, 2024 (JP) 2024-063419

(51) Int. Cl. H01M 4/36; H01M 4/02; H01M 4/131; H01M 4/134; H01M 4/38; H01M 4/485; H01M 10/0525

(52) U.S. Cl. CPC H01M 4/366; H01M 4/131; H01M 4/134; H01M 4/386; H01M 4/485; H01M 10/0525; H01M 2004/021; H01M 2004/027

(57) ABSTRACT

A secondary battery includes a positive electrode, a negative electrode, and an electrolytic solution. The negative electrode includes a negative electrode active material. The negative electrode active material includes a metal silicate. The metal silicate includes a metal element, silicon, and oxygen as constituent elements. The negative electrode active material includes a center part, a surface part, and a middle part. A ratio among a sectional area of the center part, a sectional area of the middle part, and a sectional area of the surface part in a section of the negative electrode active material is set to 1:3:5 thereby an abundance of the metal element in the middle part is greater than an abundance of the metal element in the center part, and an abundance of the metal element in the surface part is greater than the abundance of the metal element in the middle part.

### CROSS-REFERENCE TO RELATED APPLICATIONS

The present application claims priority from Japanese Patent Application No. 2024-063419 filed on Apr. 10, 2024, the entire contents of which are hereby incorporated by reference.

### BACKGROUND

The present disclosure relates to a negative electrode for a secondary battery, and to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, i.e., a negative electrode for a secondary battery, and an electrolytic solution. A configuration of the secondary battery has been considered in various ways.

For example, demand for a higher capacity and a higher cyclability characteristic is growing, which leads to need for an active material that has a higher capacity than existing negative electrode active materials.

To solve such an issue, for example, disclosed is a negative electrode active material particle having a configuration in which a silicon nanoparticle is dispersed in silicon oxide. For example, reference is made to Japanese Unexamined Patent Application Publication No. 2001-185127. In such a negative electrode active material particle, a lithium (Li)-trapping effect may be caused by oxygen, resulting in a decrease in an amount of Li that is extractable upon discharging. Such a decrease is referred to as “Li loss”. Further, large expansion of the negative electrode active material particle upon charging can cause a crack in the negative electrode active material particle. The crack can accelerate a reaction of the negative active material particle with an electrolytic solution, resulting in deterioration in cyclability characteristic.

To achieve an even higher capacity and an even higher cyclability characteristic, a technique has been disclosed in which magnesium is introduced into a negative electrode active material particle.

Introduction of magnesium into the negative electrode active material particle makes it possible to suppress occurrence of the Li loss, and the crack in the negative electrode active material particle upon charging. For example, a silicon composite oxide for a lithium secondary battery negative electrode material includes a silicon (Si) cluster and a magnesium silicic acid salt provided on a peripheral portion of the Si cluster. The magnesium silicic acid salt is represented by MgₓSiO_{y} (where 0.5≤x≤2 and 2.5≤y≤4).

For example, a negative electrode active material includes a lithium-silicon-containing oxide, and the lithium-silicon-containing oxide includes magnesium present on a surface layer of the lithium-silicon-containing oxide. There is, however, a concern that introduction of magnesium into the negative electrode active material particle results in a decrease in discharge capacity.

### SUMMARY

The present disclosure relates to a negative electrode for a secondary battery, and to a secondary battery.

A negative electrode for a secondary battery according to an embodiment of the present disclosure includes a negative electrode active material into which an electrode reactant is to be inserted and from which the electrode reactant is to be extracted. The negative electrode active material includes a metal silicate. The metal silicate includes a metal element, silicon, and oxygen as constituent elements. The metal element includes at least one of an alkaline earth metal element, an alkali metal element, a transition metal element, or an amphoteric metal element, other than a constituent element of the electrode reactant. The negative electrode active material includes a center part, a surface part, and a middle part. The center part includes the metal silicate. The surface part is positioned on an outer side of the center part and includes the metal silicate. The middle part is positioned between the center part and the surface part and includes the metal silicate. A ratio among a sectional area of the center part, a sectional area of the middle part, and a sectional area of the surface part in a section of the negative electrode active material is set to 1:3:5 thereby an abundance of the metal element in the middle part is greater than an abundance of the metal element in the center part, and an abundance of the metal element in the surface part is greater than the abundance of the metal element in the middle part.

A secondary battery according to an embodiment of the present disclosure includes a positive electrode, a negative electrode, and an electrolytic solution. The negative electrode includes a negative electrode active material into which an electrode reactant is to be inserted and from which the electrode reactant is to be extracted.

The negative electrode active material includes a metal silicate. The metal silicate includes a metal element, silicon, and oxygen as constituent elements. The metal element includes at least one of an alkaline earth metal element, an alkali metal element, a transition metal element, or an amphoteric metal element, other than a constituent element of the electrode reactant.

The negative electrode active material includes a center part, a surface part, and a middle part. The center part includes the metal silicate.

The surface part is positioned on an outer side of the center part and includes the metal silicate. The middle part is positioned between the center part and the surface part and includes the metal silicate.

A ratio among a sectional area of the center part, a sectional area of the middle part, and a sectional area of the surface part in a section of the negative electrode active material is set to 1:3:5 thereby an abundance of the metal element in the middle part is greater than an abundance of the metal element in the center part, and an abundance of the metal element in the surface part is greater than the abundance of the metal element in the middle part.

### BRIEF DESCRIPTION OF THE FIGURES

The accompanying drawings are included to provide a further understanding of the present disclosure and are incorporated in and constitute a part of this specification. The drawings illustrate example embodiments and, together with the specification, serve to explain the principles of the present disclosure.

FIG. 1 is a sectional diagram illustrating a configuration of a negative electrode for a secondary battery according to one example embodiment of the present disclosure.

FIG. 2 is an enlarged sectional diagram illustrating a configuration of a negative electrode active material.

FIG. 3 is an enlarged sectional diagram illustrating another configuration of the negative electrode active material.

FIG. 4 is a sectional diagram illustrating a configuration of a manufacturing apparatus for the negative electrode active material.

FIG. 5 is a sectional diagram illustrating a configuration of the negative electrode active material to be manufactured by the manufacturing apparatus illustrated in FIG. 4.

FIG. 6 is a sectional diagram describing a manufacturing process of the negative electrode active material.

FIG. 7 is a sectional diagram describing a manufacturing process of the negative electrode active material, following the manufacturing process illustrated in FIG. 6.

FIG. 8 is a sectional diagram illustrating a configuration of a secondary battery according to one example embodiment of the present disclosure.

FIG. 9 is an enlarged sectional diagram illustrating a configuration of a battery device illustrated in FIG. 8.

FIG. 10 is a sectional diagram illustrating a configuration of a secondary battery for testing.

### DETAILED DESCRIPTION

Although consideration has been given in various ways regarding a configuration of a secondary battery, a battery characteristic of the secondary battery is not sufficient yet. Accordingly, there is room for improvement in terms of the battery characteristic of the secondary battery. It is desirable to provide a negative electrode for a secondary battery, and a secondary battery each of which makes it possible to achieve a superior battery characteristic. In the following, one or more example embodiments of the present disclosure are described in further detail including with reference to the accompanying drawings. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following example embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

A description is given first of a negative electrode for a secondary battery according to an example embodiment of the present disclosure. The negative electrode for the secondary battery is hereinafter simply referred to as a “negative electrode”.

The negative electrode described here may be used in a secondary battery, which is an electrochemical device. However, in some embodiments, the negative electrode may be used in electrochemical devices other than the secondary battery. Non-limiting examples of the other electrochemical devices may include a primary battery and a capacitor.

The negative electrode may allow an electrode reactant to be inserted into and extracted from the negative electrode upon an electrode reaction. Although not particularly limited in kind, the electrode reactant may be, for example, a light metal such as an alkali metal or an alkaline earth metal. Non-limiting examples of the alkali metal may include lithium, sodium, and potassium. Non-limiting examples of the alkaline earth metal may include magnesium and calcium.

Examples are given below of a case where the electrode reactant is lithium. Accordingly, lithium may be inserted into and extracted from the negative electrode in an ionic state upon the electrode reaction.

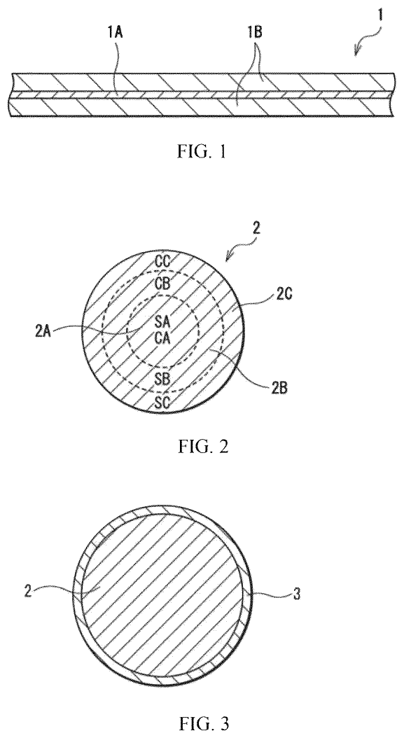

FIG. 1 illustrates a sectional configuration of a negative electrode 1 as an example of the negative electrode. The negative electrode 1 may include, as illustrated in FIG. 1, a negative electrode current collector 1A and a negative electrode active material layer 1B. In some embodiments, however, the negative electrode current collector 1A may be omitted.

The negative electrode current collector 1A may be an electrically conductive member that supports the negative electrode active material layer 1B. The negative electrode current collector 1A may include any one or more of electrically conductive materials including, without limitation, a metal material. Non-limiting examples of the electrically conductive material may include copper. The negative electrode current collector 1A here may have two opposed surfaces on each of which the negative electrode active material layer 1B is to be provided.

In an embodiment, a surface of the negative electrode current collector 1A on which the negative electrode active material layer 1B is to be provided may be roughened. One reason for this is that this helps to improve adherence of the negative electrode active material layer 1B to the negative electrode current collector 1A, owing to what is called an anchor effect. A roughening method is not particularly limited, and may be, for example, a method in which microparticles are formed on a surface of a metal foil through an electrolytic treatment. In the electrolytic treatment, the microparticles may be formed on the surface of the metal foil by an electrolytic method in an electrolyzer. This may provide the surface of the metal foil with asperities.

The negative electrode active material layer 1B may be provided on the surface of the negative electrode current collector 1A. The negative electrode active material layer 1B may include a negative electrode active material 2 (see FIG. 2 to be described later). In some embodiments, the negative electrode active material layer 1B may further include a negative electrode binder, a negative electrode conductor, or both. A method of forming the negative electrode active material layer 1B is not particularly limited, and may include, for example, any one or more of methods including, without limitation, a coating method, a vapor-phase method, a liquid-phase method, a thermal spraying method, and a firing or sintering method.

The negative electrode active material layer 1B here may be provided on each of the two opposed surfaces of the negative electrode current collector 1A. In some embodiments, the negative electrode active material layer 1B may be provided only on one of the two opposed surfaces of the negative electrode current collector 1A. Here, a section of the negative electrode active material 2 may be classified by observing the section of the negative electrode active material 2 by an electron microscope and thereafter performing image processing on an electron micrograph as a result of the observation. The section of the negative electrode active material 2 may be thus classified into a center part, a middle part, and a surface part. Details of a procedure for classifying the section of the negative electrode active material 2 will be described later. An abundance of a metal element in the negative electrode active material 2 may be measured by analyzing the section of the negative electrode active material 2 through elemental analysis, thus measuring each of an abundance of the metal element in the surface part, an abundance of the metal element in the middle part, and an abundance of the metal element in the center part. Details of a procedure for measuring the abundance of the metal element in the negative electrode active material 2 will be described later.

The negative electrode active material 2 may be a material into which lithium as an electrode reactant is to be inserted and from which lithium is to be extracted. In an embodiment, multiple negative electrode active materials 2 each having a particle shape may be used. The negative electrode active material 2 may include any one or more of metal silicates. The metal silicate may have superior lithium insertability, which helps to obtain a high energy density. The metal silicate may also have superior physical durability upon the electrode reaction, which helps to suppress damage to the negative electrode active material 2 and to decrease reactivity of a surface of the negative electrode active material 2.

The metal silicate includes a metal element, silicon, and oxygen as constituent elements. The metal element includes at least one of an alkaline earth metal element, an alkali metal element, a transition metal element, or an amphoteric metal element, other than a constituent element of the electrode reactant.

In an embodiment, the metal element may include only the alkaline earth metal element. In an embodiment, the metal element may include only the alkali metal element. In an embodiment, the metal element may include only the transition metal element. In an embodiment, the metal element may include only the amphoteric metal element. In an embodiment, the metal element may include any two or more of the alkaline earth metal element, the alkali metal element, the transition metal element, or the amphoteric metal element. In an embodiment, the metal element may include both the alkaline earth metal element and the alkali metal element. In these cases, only one alkaline earth metal element may be used, or two or more alkaline earth metal elements may be used. Similarly, only one alkali metal element may be used, or two or more alkali metal elements may be used. Similarly, only one transition metal element may be used, or two or more transition metal elements may be used. Similarly, only one amphoteric metal element may be used, or two or more amphoteric metal elements may be used.

Non-limiting examples of the alkaline earth metal element may include magnesium and calcium. Non-limiting examples of the alkali metal element may include lithium, sodium, and potassium.

However, the constituent element of the electrode reactant is excluded from the metal element as a constituent element of the metal silicate described here. Accordingly, lithium, which is the constituent element of the electrode reactant, is excluded from the metal element.

One reason why the negative electrode active material 2 includes the metal silicate is that, as will be described later, a distribution of the metal element in the negative electrode active material 2 is made appropriate, which helps to decrease reactivity in the vicinity of the surface of the negative electrode active material 2 and to improve lithium insertability and lithium extractability in the vicinity of a center of the negative electrode active material 2. An example detailed configuration of the negative electrode active material 2 regarding the distribution of the metal element will be described later.

The metal silicate is not particularly limited in configuration as long as the metal silicate includes the metal element, silicon, and oxygen as constituent elements.

In an embodiment, the metal silicate may include any one or more of a first metal silicate, a second metal silicate, a third metal silicate, a fourth metal silicate, or a fifth metal silicate.

In other words, the metal silicate may include only one of the first metal silicate, the second metal silicate, the third metal silicate, the fourth metal silicate, or the fifth metal silicate, or may include any two or more of the first metal silicate, the second metal silicate, the third metal silicate, the fourth metal silicate, or the fifth metal silicate.

The first metal silicate may be a compound represented by Formula (1). Only one first metal silicate may be used, or two or more first metal silicates may be used.

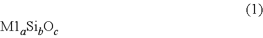

where:
M1 is at least one of alkaline earth metal elements;
a satisfies 0<a<4;
b satisfies 0<b<5; and
c satisfies 0<c<7.

The first metal silicate may be a compound including the alkaline earth metal element, silicon, and oxygen as constituent elements, as represented by Formula (1). Non-limiting examples of the first metal silicate may include MgSiO₃, Mg₂SiO₄, Mg₂Si₂O₆, BeSiO₃, Be₂SiO₄, CaSiO₃, Ca₂SiO₄, Ca₂SiO₄, Ca₃SiO₅, Ca₂SiO₄, CaSiO₃, SrSiO₃, Sr₂SiO₄, BaSiO₃, and Ba₂SiO₄.

The second metal silicate may be a compound represented by Formula (2). Only one second metal silicate may be used, or two or more second metal silicates may be used.

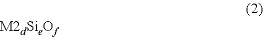

where:
M2 is at least one of alkali metal elements;
d satisfies 1<d<7;
e satisfies 0<e<5; and
f satisfies 2<f<10.

The second metal silicate may be a compound including the alkali metal element, silicon, and oxygen as constituent elements, as represented by Formula (2). Non-limiting examples of the second metal silicate may include Li₂SiO₃, Li₂Si₂O₅, Li₆Si₂O₇, Li₄SiO₄, Na₂SiO₃, Na₄SiO₄, Na₂Si₂O₅, Na₂Si₄O₉, K₂SiO₃, and Rb₂SiO₃.

The third metal silicate may be a compound represented by Formula (3). Only one third metal silicate may be used, or two or more third metal silicates may be used.

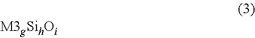

where:
M3 is at least one of transition metal elements;
g satisfies 0<g<3;
h satisfies 0<h<2; and
i satisfies 2<i<5.

The third metal silicate may be a compound including the transition metal element, silicon, and oxygen as constituent elements, as represented by Formula (3). Non-limiting examples of the third metal silicate may include Fe₂SiO₄, FeSiO₄, Cu₂SiO₄, Ni₂SiO₄, Co₂SiO₃, Mn₂SiO₄, and ZrSiO₄.

The fourth metal silicate may be a compound represented by Formula (4). Only one fourth metal silicate may be used, or two or more fourth metal silicates may be used.

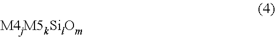

where:
M4 is at least one of alkali metal elements;
M5 is at least one of an alkaline earth metal element, a transition metal element, or an amphoteric metal element;
j satisfies 0<j<3;
k satisfies 0<k<3;
l satisfies 0<1<4; and
m satisfies 2<m<7.

The fourth metal silicate may be a compound including the alkali metal element, at least one of the alkaline earth metal element, the transition metal element, or the amphoteric metal element, silicon, and oxygen as constituent elements, as represented by Formula (4). Non-limiting examples of the fourth metal silicate may include Li₂MgSiO₄, Na₂MgSiO₄, K₂MgSiO₄, Li₂CaSiO₄, Na₂CaSiO₄, Na₂CaSiO₄, LiAlSi₂O₆, and NaAlSi₂O₆.

The fifth metal silicate may be a compound represented by Formula (5). Only one fifth metal silicate may be used, or two or more fifth metal silicates may be used.

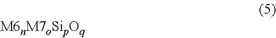

where:
M6 is at least one of alkaline earth metal elements;
M7 is at least one of an alkaline earth metal element, a transition metal element, or an amphoteric metal element;
n satisfies 0<n<4;
satisfies 0<o<3;
p satisfies 0<p<4; and
q satisfies 2<q<7.

The fifth metal silicate may be a compound including the alkaline earth metal element, at least one of the alkaline earth metal element, the transition metal element, or the amphoteric metal element, silicon, and oxygen as constituent elements, as represented by Formula (5). Non-limiting examples of the fifth metal silicate may include CaMgSiO₄, Ca₂MgSi₂O₆, Ca₂MnSi₂O₆, Ca₂ZnSi₂O₆, Ca₂FeSi₂O₆, and MnMgSi₂O₆.

In an embodiment, the metal silicate may include the first metal silicate. One reason for this is that the first metal silicate helps to sufficiently decrease the reactivity in the vicinity of the surface of the negative electrode active material 2 and to sufficiently improve the lithium insertability and lithium extractability in the vicinity of the center of the negative electrode active material 2.

In an embodiment, in the first metal silicate, the alkaline earth metal element may include magnesium. For example, the metal silicate may include MgₐSiO_{b} that is the first metal silicate. One reason for this is that MgₐSiO_{b} helps to further decrease the reactivity in the vicinity of the surface of the negative electrode active material 2 and to further improve the lithium insertability and lithium extractability in the vicinity of the center of the negative electrode active material 2.

A content of the metal element in the negative electrode active material 2 is not particularly limited. In an embodiment, an abundance rate, i.e., a rate of a content of the metal element to a sum of the content (mol) of the metal element, a content (mol) of silicon, and a content (mol) of oxygen may be within a range from 1 mol % to 20 mol % both inclusive. One reason for this is that the abundance rate is made appropriate, which helps to sufficiently decrease the reactivity in the vicinity of the surface of the negative electrode active material 2 and to sufficiently improve the lithium insertability and lithium extractability in the vicinity of the center of the negative electrode active material 2. A metal content rate (%) may be calculated based on the following calculation expression: metal content rate=[content of metal element/(content of metal element+content of silicon+content of oxygen)]×100.

A procedure for calculating the metal content rate may be as described below. In the following, a description is given of a case where the negative electrode active material layer 1B includes the negative electrode binder and the negative electrode conductor together with the negative electrode active material 2.

First, the negative electrode 1 may be put into a solvent. The solvent may include any one of a nonaqueous solvent or an aqueous solvent that allows for dissolution of the negative electrode binder. Non-limiting examples of the nonaqueous solvent may include N-methylpyrrolidone (NMP). Non-limiting examples of the aqueous solvent may include water. The negative electrode binder may thereby be dissolved in the solvent. As a result, a solution including a negative electrode binder-dissolved material may be obtained.

Thereafter, the solution may be filtered. As a result, a filtrate including the negative electrode binder-dissolved material may be obtained, and a residue separated from the filtrate may be obtained. The residue may include a mixture of the negative electrode current collector 1A, the negative electrode active material 2, and the negative electrode conductor that have not been dissolved in the solvent. Thereafter, the negative electrode current collector 1A may be removed from the mixture to thereby obtain a mixture of the negative electrode active material 2 and the negative electrode conductor.

Thereafter, the mixture may be subjected to a separation process by a separator such as a centrifugal separator to thereby collect the negative electrode active material 2 from the mixture.

Thereafter, the negative electrode active material 2 may be analyzed by any one or more of composition analysis methods including, without limitation, inductively coupled plasma (ICP) optical emission spectroscopy and a non-dispersive infrared absorption method to thereby measure the content (mol) of the metal element, the content (mol) of silicon, and the content (mol) of oxygen.

Thereafter, the metal content rate may be calculated based on the calculation expression described above using the content of the metal element, the content of silicon, and the content of oxygen.

A mixture ratio between silicon and oxygen in the negative electrode active material 2 is not particularly limited. In an embodiment, an oxygen-silicon ratio, i.e., a ratio of the content (mol) of oxygen to the content (mol) of silicon may be within a range from 0.80 to 1.30 both inclusive. One reason for this is that the oxygen-silicon ratio is made appropriate, which helps to sufficiently decrease the reactivity in the vicinity of the surface of the negative electrode active material 2 and to sufficiently improve the lithium insertability and lithium extractability in the vicinity of the center of the negative electrode active material 2. The oxygen-silicon ratio may be calculated based on the following calculation expression: oxygen-silicon ratio=content of oxygen/content of silicon.

When the oxygen-silicon ratio is to be calculated, each of the content of silicon and the content of oxygen may be measured by a method such as the non-dispersive infrared absorption method, following which the oxygen-silicon ratio may be calculated based on the calculation expression described above.

A crystalline state of the negative electrode active material 2 is not particularly limited. In an embodiment, a crystallite size of a Si(220) crystal plane may be less than or equal to 30 nm. One reason for this is that the crystallite size is made appropriate, which helps to sufficiently decrease the reactivity in the vicinity of the surface of the negative electrode active material 2 and to sufficiently improve the lithium insertability and lithium extractability in the vicinity of the center of the negative electrode active material 2. In an embodiment, the crystallite size of the Si(220) crystal plane may be 0 nm. That is, silicon may be amorphous.

The crystallite size may be measured by analyzing the negative electrode active material 2 by any one or more of crystal structure analysis methods including, without limitation, X-ray diffractometry (XRD).

In an embodiment, the multiple negative electrode active materials 2 each having the particle shape may be used, and the negative electrode active material layer 1B may therefore include the multiple negative electrode active materials 2 each having the particle shape. In this case, an average particle size of the multiple negative electrode active materials 2 each having the particle shape is not particularly limited. In an embodiment, a median diameter of the multiple negative electrode active materials 2 each having the particle shape may be within a range from 0.1 μm to 50 μm both inclusive. In an embodiment, the median diameter of the multiple negative electrode active materials 2 each having the particle shape may be within a range from 3 μm to 15 μm both inclusive. One reason for this is that the median diameter is made appropriate, which helps to sufficiently decrease the reactivity in the vicinity of the surface of the negative electrode active material 2 and to sufficiently improve the lithium insertability and lithium extractability in the vicinity of the center of the negative electrode active material 2.

The median diameter may be measured by analyzing the multiple negative electrode active materials 2 by, for example, a laser diffraction particle size distribution analyzer.

In an embodiment, the negative electrode active material 2 may include a simple substance of silicon, a silicon oxide, or both. One reason for this is that this helps to further decrease the reactivity in the vicinity of the surface of the negative electrode active material 2 and to further improve the lithium insertability and lithium extractability in the vicinity of the center of the negative electrode active material 2.

The “simple substance of silicon” described here may merely refer to a simple substance of silicon in a general sense. The simple substance of silicon may thus include a small amount of impurity. For example, purity of the simple substance of silicon is not limited to 100%.

The silicon oxide may be a compound including silicon and oxygen as constituent elements. In an embodiment, the silicon oxide may be a compound represented by Formula (6).

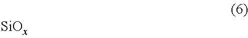

where x satisfies 0<x≤2.

A value of x is not particularly limited as long as the value of x is within the range described above. In an embodiment, x may satisfy 0.5≤x≤1.5. One reason for this is that this helps to further decrease the reactivity in the vicinity of the surface of the negative electrode active material 2 and to further improve the lithium insertability and lithium extractability in the vicinity of the center of the negative electrode active material 2.

The negative electrode binder may include any one or more of materials including, without limitation, a synthetic rubber and a polymer compound. Non-limiting examples of the synthetic rubber may include a styrene-butadiene-based rubber, a fluorine-based rubber, and ethylene propylene diene. Non-limiting examples of the polymer compound may include polyvinylidene difluoride, polyimide, polyamide, carboxymethyl cellulose, a metal salt of carboxymethyl cellulose, a polyacrylic acid, and a metal salt the polyacrylic acid.

The negative electrode conductor may include any one or more of electrically conductive materials including, without limitation, a carbon material, a metal material, and an electrically conductive polymer compound. Non-limiting examples of the carbon material may include graphite, carbon black, acetylene black, a carbon nanotube, a carbon nanofiber, and Ketjen black.

In an embodiment, the negative electrode active material layer 1B may further include any one or more of other materials.

The one or more other materials are not particularly limited in kind. The one or more other materials may each be another negative electrode active material. The other negative electrode active material may be a carbon material. Non-limiting examples of the carbon material may include graphitizable carbon, non-graphitizable carbon, and graphite. The graphite may be natural graphite or artificial graphite, or may include both.

The negative electrode active material layer 1B further including the carbon material as the other negative electrode active material helps to prevent damage to the negative electrode active material layer 1B, while securing a battery capacity in a secondary battery including the negative electrode 1.

For example, while the negative electrode active material 2 including silicon as a constituent element, i.e., the metal silicate, may have an advantage of having a high theoretical capacity, there may be a concern that the negative electrode active material 2 easily expands and contracts greatly upon charging and discharging of the secondary battery including the negative electrode 1. In contrast, while there may be a concern that the other negative electrode active material, i.e., the carbon material has a low theoretical capacity, the other negative electrode active material may have an advantage of not easily expanding and contracting upon charging and discharging of the secondary battery including the negative electrode 1. Thus, the combined use of the metal silicate and the carbon material helps to suppress expansion and contraction of the negative electrode active material layer 1B upon charging and discharging while achieving a high theoretical capacity. This helps to prevent damage to the negative electrode active material layer 1B, while securing the battery capacity, as described above.

Each of the simple substance of silicon and the silicon oxide may have a tendency similar to the tendency of the metal silicate described above. One reason for this is that each of the simple substance of silicon and the silicon oxide includes silicon as a constituent element, as with the metal silicate.

The negative electrode active material 2 includes the metal silicate, as described above. The metal element may be dispersed inside the negative electrode active material 2 in a wide range from the vicinity of the surface of the negative electrode active material 2 to the vicinity of the center of the negative electrode active material 2. The metal element may thus be present in an entire region inside the negative electrode active material 2, not being limited to a partial region inside the negative electrode active material 2.

In this case, a distribution of the metal silicate inside the negative electrode active material 2, i.e., a state of the metal element present inside the negative electrode active material 2 may be so made appropriate as to be a predetermined state.

For example, the abundance of the metal element in the negative electrode active material 2 may decrease in a direction from the surface of the negative electrode active material 2 to the center of the negative electrode active material 2. For example, the metal silicate may be dispersed widely in the entire region inside the negative electrode active material 2; however, an amount of the dispersed metal silicate may decrease in the direction from the surface of the negative electrode active material 2 to the center of the negative electrode active material 2. Accordingly, the abundance of the metal element as a constituent element of the metal silicate may decrease in the direction from the surface of the negative electrode active material 2 to the center of the negative electrode active material 2.

In an embodiment, the abundance of the metal element may continuously decrease in the direction from the surface of the negative electrode active material 2 to the center of the negative electrode active material 2. In an embodiment, the abundance of the metal element may discontinuously decrease in the direction from the surface of the negative electrode active material 2 to the center of the negative electrode active material 2. In an embodiment, there may be mixed a region in which the abundance of the metal element continuously decreases in the direction from the surface of the negative electrode active material 2 to the center of the negative electrode active material 2 and a region in which the abundance of the metal element discontinuously decreases in the direction from the surface of the negative electrode active material 2 to the center of the negative electrode active material 2. In an embodiment, a gradient when the abundance of the metal element decreases in the direction from the surface of the negative electrode active material 2 to the center of the negative electrode active material 2 may be constant. In an embodiment, the gradient may not be constant and may change once or more between the surface of the negative electrode active material 2 and the center of the negative electrode active material 2.

For example, when the abundance of the metal element decreases in the direction from the surface of the negative electrode active material 2 to the center of the negative electrode active material 2, a predetermined relationship of the abundance of the metal element may be satisfied.

FIG. 2 illustrates a sectional configuration of the negative electrode active material 2 in an enlarged manner. To simplify the illustration, the negative electrode active material 2 in FIG. 2 has a circular sectional shape. The sectional shape of the negative electrode active material 2 is not particularly limited. In an embodiment, the sectional shape of the negative electrode active material 2 may include any one or more shapes without limitation to the circular shape.

As illustrated in FIG. 2, the section of the negative electrode active material 2 may be classified into three regions that are different from each other and adjacent to each other. The three regions may include a center part 2A, a middle part 2B, and a surface part 2C.

Here, the wording “classifying the section of the negative electrode active material 2” may mean that the section of the negative electrode active material 2 is so segmented as to identify the three regions different from each other, i.e., the center part 2A, the middle part 2B and the surface part 2C, rather than that the negative electrode active material 2 is so divided as to obtain the center part 2A, the middle part 2B, and the surface part 2C that are separated from each other.

The center part 2A may be a region positioned on an innermost side of the negative electrode active material 2, and includes the metal silicate. The surface part 2C may be a region positioned on an outermost side of the negative electrode active material 2, and includes the metal silicate. The middle part 2B may be a region positioned between the center part 2A and the surface part 2C and adjacent to each of the center part 2A and the surface part 2C, and includes the metal silicate. The middle part 2B may thus be positioned on an outer side of the center part 2A, and the surface part 2C may be positioned on the outer side of the middle part 2B.

One reason why each of the center part 2A, the middle part 2B, and the surface part 2C includes the metal silicate is that the metal element is present inside the negative electrode active material 2 in the wide range from the vicinity of the surface of the negative electrode active material 2 to the vicinity of the center of the negative electrode active material 2, as described above.

The center part 2A, the middle part 2B, and the surface part 2C may be identified by sectional areas.

For example, as illustrated in FIG. 2, the center part 2A, the middle part 2B, and the surface part 2C in the section of the negative electrode active material 2 may be set by setting a sectional area SA of the center part 2A, a sectional area SB of the middle part 2B, and a sectional area SC of the surface part 2C to satisfy the following ratio: sectional area SA:sectional area SB:sectional area SC=1:3:5. Here, assuming that each of an outer surface of the center part 2A, an outer surface of the middle part 2B, and an outer surface of the surface part 2C is a surface of a sphere, a ratio among a radius of the center part 2A, a radius of the middle part 2B, and a radius of the surface part 2C may be set to 1:2:3.

In this case, as described above, the center part 2A, the middle part 2B, and the surface part 2C each include the metal silicate, and the abundance of the metal element inside the negative electrode active material 2 may decrease in the direction from the surface of the negative electrode active material 2 to the center of the negative electrode active material 2.

Thus, an abundance CC of the metal element in the surface part 2C may be greater than an abundance CB of the metal element in the middle part 2B, and the abundance CB of the metal element in the middle part 2B may be greater than an abundance CA of the metal element in the center part 2A. That is, the abundances CA, CB, and CC of the metal element in the negative electrode active material 2 may satisfy an appropriate relationship of CC>CB>CA.

One reason why the abundances CA, CB, and CC satisfy the appropriate relationship of CC>CB>CA is that the distribution of the metal element inside the negative electrode active material 2 is made appropriate because of the above-described reason, which helps to decrease the reactivity in the vicinity of the surface of the negative electrode active material 2 and to improve the lithium insertability and lithium extractability in the vicinity of the center of the negative electrode active material 2. This helps to suppress a decomposition reaction of the electrolytic solution and to increase the battery capacity in the secondary battery including the negative electrode 1.

For example, when the metal silicate is used in the negative electrode active material 2, because the metal silicate includes the metal element as a constituent element, physical durability in the vicinity of the surface of the negative electrode active material 2 improves. This helps to suppress damage to the negative electrode active material 2 caused by expansion and contraction of the negative electrode active material 2 upon charging and discharging in the secondary battery including the negative electrode 1, and thus helps to suppress formation of a new surface of the negative electrode active material 2 having high reactivity. This helps to decrease the reactivity of the negative electrode active material 2, and thus helps to suppress the decomposition reaction of the electrolytic solution in the vicinity of the surface of the negative electrode active material 2. This in turn helps to suppress formation of a film caused by the decomposition reaction of the electrolytic solution upon charging and discharging, and thus helps to reduce an increase in electric resistance of the negative electrode active material 2.

When the metal silicate is used in the negative electrode active material 2, in the secondary battery including the negative electrode 1, a film having high resistance derived from the metal silicate may be formed upon charging and discharging. Use of the film helps to electrochemically protect the surface of the negative electrode active material 2. This helps to decrease the reactivity of the negative electrode active material 2, and thus helps to further suppress the decomposition reaction of the electrolytic solution on the surface of the negative electrode active material 2.

However, when the abundance of the metal element in the metal silicate becomes excessive, the lithium insertability and lithium extractability in the vicinity of the center of the negative electrode active material 2 may decrease. This may decrease a discharge capacity per weight of the negative electrode active material 2 in the secondary battery including the negative electrode 1, and may thus decrease the battery capacity.

Based upon the foregoing, a trade-off relationship may be exhibited in which improvement of one of two characteristics, i.e., suppression of the decomposition reaction of the electrolytic solution and improvement in the lithium insertability and lithium extractability causes degradation of another of the two characteristics depending on the abundance of the metal element in the metal silicate.

For example, when the abundance of the metal element in the metal silicate decreases, the abundance of the metal element may decrease in the vicinity of the surface of the negative electrode active material 2, and the abundance of the metal element may decrease also in the vicinity of the center of the negative electrode active material 2.

In this case, the abundance of the metal element may decrease in the vicinity of the center of the negative electrode active material 2, which helps to improve the lithium insertability and lithium extractability. Meanwhile, the abundance of the metal element may decrease in the vicinity of the surface of the negative electrode active material 2, which may decrease physical durability. Accordingly, in the secondary battery including the negative electrode 1, the battery capacity may increase but the decomposition reaction of the electrolytic solution may be accelerated. A trade-off relationship may thus be exhibited.

Further, when the abundance of the metal element in the metal silicate increases, the abundance of the metal element may increase in the vicinity of the surface of the negative electrode active material 2, and the abundance of the metal element may increase also in the vicinity of the center of the negative electrode active material 2.

In this case, the abundance of the metal element may increase in the vicinity of the surface of the negative electrode active material 2, which helps to improve the physical durability. Meanwhile, the abundance of the metal element may increase in the vicinity of the center of the negative electrode active material 2, which may decrease the lithium insertability and lithium extractability. Accordingly, in the secondary battery including the negative electrode 1, the decomposition reaction of the electrolytic solution may be suppressed but the battery capacity may decrease. A trade-off relationship may thus be exhibited.

In contrast, when the abundance of the metal element decreases in the direction from the surface of the negative electrode active material 2 to the center of the negative electrode active material 2, thus allowing the abundances CA, CB, and CC to satisfy the appropriate relationship of CC>CB>CA, the abundance of the metal element may increase in the vicinity of the surface of the negative electrode active material 2, and the abundance of the metal element may decrease in the vicinity of the center of the negative electrode active material 2.

In this case, the abundance of the metal element may increase in the vicinity of the surface of the negative electrode active material 2, which helps to improve the physical durability. Further, the abundance of the metal element may decrease in the vicinity of the center of the negative electrode active material 2, which helps to improve the lithium insertability and lithium extractability. In the secondary battery including the negative electrode 1, the trade-off relationship described above is overcome. This helps to suppress the decomposition reaction of the electrolytic solution and to increase the battery capacity.

In this case, for example, the metal element may be present in the entire region inside the negative electrode active material 2, which helps to further suppress damage to the negative electrode active material 2, unlike when the metal element is present only in the partial region inside the negative electrode active material 2.

For example, when the metal element is present only in the partial region inside the negative electrode active material 2, an interface may be formed between a region in which the metal element is present and a region in which the metal element is not present. Thus, in the secondary battery including the negative electrode 1, damage to the negative electrode active material 2 from the interface as a start point may be accelerated when the negative electrode active material 2 expands or contracts upon charging and discharging.

In contrast, when the metal element is present in the entire region inside the negative electrode active material 2, the interface may be absent between the region in which the metal element is present and the region in which the metal element is not present. This helps to suppress damage to the negative electrode active material 2 from the interface as a start point in the secondary battery including the negative electrode 1, even when the negative electrode active material 2 expands or contracts upon charging and discharging.

A procedure for classifying the section of the negative electrode active material 2 into the center part 2A, the middle part 2B, and the surface part 2C may be as described below. In the following, a description is given of a case where the negative electrode active material layer 1B includes the negative electrode binder and the negative electrode conductor together with the negative electrode active material 2.

First, the negative electrode active material 2 may be collected from the negative electrode 1 by a procedure similar to the procedure for calculating the metal content rate described above.

Thereafter, the negative electrode active material 2 may be cut by a cutting tool such as a microtome or an ion miller to thereby expose a section of the negative electrode active material 2. Thereafter, the section of the negative electrode active material 2 may be observed by any one or more of electron microscopes including, without limitation, a scanning electron microscope to thereby obtain an electron micrograph as a result of the observation of the section of the negative electrode active material 2.

Thereafter, sectional areas of multiple regions in the negative electrode active material 2 may be calculated through image processing based on the electron micrograph.

In this case, a sectional area of the negative electrode active material 2 defined by an outer edge of the section of the negative electrode active material 2 may be calculated based on the outer edge of the section of the negative electrode active material 2.

Thereafter, image processing may be performed on the section of the negative electrode active material 2 by moving the entire outer edge of the section of the negative electrode active material 2 toward the inner side of the negative electrode active material 2 by a predetermined distance to thereby allow a size of the section after the movement of the outer edge to be slightly smaller than the size of the section before the movement of the outer edge. The predetermined distance may be referred to as a moving distance.

A sectional area of the negative electrode active material 2 defined by the outer edge after the movement may thus be calculated. Further, a sectional area of a peripheral region of the negative electrode active material 2 defined by the outer edge after the movement may be calculated by subtracting the sectional area of the negative electrode active material 2 defined by the outer edge after the movement from the sectional area of the negative electrode active material 2 defined by the outer edge before the movement The peripheral region of the negative electrode active material 2 defined by the outer edge after the movement may be a region having what is called a ring shape.

Note that the moving distance is not particularly limited, and may be set as desired. For example, the moving distance may be 0.8 μm. In this case, a smaller moving distance helps to more easily classify the section of the negative electrode active material 2 into the center part 2A, the middle part 2B, and the surface part 2C with high accuracy.

Thereafter, the following process may be repeated multiple times. In the process, the entire outer edge of the section of the negative electrode active material 2 may be moved further toward the inner side of the negative electrode active material 2, following which the sectional area of the negative electrode active material 2 defined by the outer edge after the movement may be calculated, and the sectional area of the peripheral region of the negative electrode active material 2 defined by the outer edge after the movement may be calculated. The multiple sectional areas of the negative electrode active material 2 may thus be obtained, and the multiple sectional areas of the peripheral regions may thus be obtained.

The number of times to repeat the calculation of each of the sectional area of the negative electrode active material 2 and the sectional area of the peripheral region is not particularly limited, and may be set as desired. In this case, a larger number of times to repeat the calculation helps to more easily classify the section of the negative electrode active material 2 into the center part 2A, the middle part 2B, and the surface part 2C with high accuracy.

After the sectional areas of multiple regions in the negative electrode active material 2 are calculated through image processing by repeating each of the calculation of the sectional area of the negative electrode active material 2 and the calculation of the sectional area of the peripheral region, calculation may be made of a sectional area of an inner region positioned on the inner side of the negative electrode active material 2, a sectional area of an outer region positioned on the outer side of the negative electrode active material 2, and a sectional area of a middle region positioned between the inner region and the outer region.

The sectional area of the inner region may be a sum of the sectional area of the negative electrode active material 2 defined by the outer edge when the outer edge is moved to an innermost side, and one or more sectional areas of one or more peripheral regions positioned on the outer side of the negative electrode material 2. The sectional area of the outer region may be a sum of one or more sectional areas of one or more peripheral regions positioned on the outer side of the negative electrode active material 2. The sectional area of the middle region may be a sum of one or more sectional areas of one or more peripheral regions positioned between the inner region and the outer region.

In this case, the number of the sectional areas of the inner region, the number of the sectional areas of the middle region, and the number of the sectional areas of the outer region may each be so adjusted as to allow a ratio among the sectional area of the inner region, the sectional area of the middle region, and the sectional area of the outer region to be 1:3:5.

Thus, the inner region may correspond to the center part 2A having the sectional area SA. The middle region may correspond to the middle part 2B having the sectional area SB. The outer region may correspond to the surface part 2C having the sectional area SC. The center part 2A, the middle part 2B, and the surface part 2C may each be identified by corresponding one of the sectional areas SA, SB, and SC, which may classify the section of the negative electrode active material 2 into the center part 2A, the middle part 2B, and the surface part 2C.

When the abundances CA, CB, and CC of the metal element are to be measured, the negative electrode active material 2 may be collected from the negative electrode 1 and the section of the negative electrode active material 2 may be exposed by a procedure similar to the procedure for calculating the metal content rate described above, following which the section of the negative electrode active material 2 may be analyzed by any one or more of elemental analysis methods including, without limitation, energy dispersive x-ray spectroscopy (EDX).

In this case, the abundance CA may be measured by analyzing the center part 2A. The abundance CB may be measured by analyzing the middle part 2B. The abundance CC may be measured by analyzing the surface part 2C.

Thus, the abundances CA, CB, and CC may be obtained, which makes it possible to identify the relationship among the abundances CA, CB, and CC.

One reason why the section of the negative electrode active material 2 is classified into the three regions, i.e., the center part 2A, the middle part 2B, and the surface part 2C, is to make it possible to confirm, afterwards with high accuracy, the decrease in the abundance of the metal element in the direction from the surface of the negative electrode active material 2 to the center of the negative electrode active material 2 inside the negative electrode active material 2.

For example, assume that the section of the negative electrode active material 2 is separated into two regions, i.e., an inner part and an outer part. The outer part is positioned on the outer side of the inner part.

In this case also, when an abundance of the metal element in the inner part and an abundance of the metal element in the outer part are measured, and the abundance of the metal element in the inner part is smaller than the abundance of the metal element in the outer part, the abundance of the metal element may seem to decrease in the direction from the surface of the negative electrode active material 2 to the center of the negative electrode active material 2.

However, there is a concern when the abundances of the metal element in only two regions are compared with each other.

For example, when the abundance of the metal element in the inner part and the abundance of the metal element in the outer part are to be made equal to each other, uneven dispersion of the metal element inside the negative electrode active material 2 due to some event can unintentionally make the abundance of the metal element in the outer part greater than the abundance of the metal element in the inner part. In this case, even if there is no positive intention to make the abundance of the metal element in the outer part greater than the abundance of the metal element in the inner part, the abundance of the metal element in the outer part can accidentally become greater than the abundance of the metal element in the inner part.

In contrast, when the section of the negative electrode active material 2 is classified into the three regions, i.e., the center part 2A, the middle part 2B, and the surface part 2C, the abundances of the metal element in the three regions may be to be compared with each other.

In this case, a possibility is reduced that the abundance CA unintentionally becomes greater than the abundance CB and the abundance CB unintentionally becomes greater the abundance CA, unlike when the section of the negative electrode active material 2 is classified into the two regions, i.e., the inner part and the outer part. One reason for this is that without positive intention to make the abundance CC greater than the abundance CB and to make the abundance CB greater than the abundance CA, it is difficult for the abundances CA, CB, and CC described above to satisfy the appropriate relationship of CC>CB>CA.

Accordingly, classifying the section of the negative electrode active material 2 into the three regions, i.e., the center part 2A, the middle part 2B, and the surface part 2C, helps to confirm, afterwards with high accuracy, the decrease in the abundance of the metal element in the direction from the surface of the negative electrode active material 2 to the center of the negative electrode active material 2 inside the negative electrode active material 2.

FIG. 3 illustrates another sectional configuration of the negative electrode active material 2 in an enlarged manner, and corresponds to FIG. 2.

As illustrated in FIG. 3, the negative electrode active material layer 1B may further include a film 3 provided on the surface of the negative electrode active material 2. In an embodiment, the film 3 may cover the surface of the negative electrode active material 2.

In an embodiment, the film 3 may cover the entire surface of the negative electrode active material 2. In an embodiment, the film 3 may cover only a portion of the surface of the negative electrode active material 2. When the film 3 covers only a portion of the surface of the negative electrode active material 2, in an embodiment, multiple films 3 may be provided on the surface of the negative electrode active material 2 at respective locations separate from each other.

For example, the film 3 may include an electrically conductive material. For example, the film 3 may include a carbon material. One reason for this is that electrical conductivity of the negative electrode active material 2 improves. A method of forming the film 3 will be described in detail later.

In the negative electrode 1, upon an electrode reaction, lithium may be inserted, in an ionic state, into the negative electrode active material 2 included in the negative electrode active material layer 1B, and lithium may be extracted, in an ionic state, from the negative electrode active material 2.

The negative electrode 1 may be manufactured by an example procedure to be described below.

Here, a description is given first of a procedure for manufacturing the negative electrode active material 2 illustrated in FIGS. 2 and 3, and thereafter of a procedure for manufacturing the negative electrode 1 including the negative electrode active material 2.

The negative electrode active material 2 may be manufactured by a predetermined manufacturing apparatus. Accordingly, in the description of the procedure for manufacturing the negative electrode active material 2, a description is given first of a configuration of the manufacturing apparatus, and thereafter of the procedure for manufacturing the negative electrode active material 2 by the manufacturing apparatus.

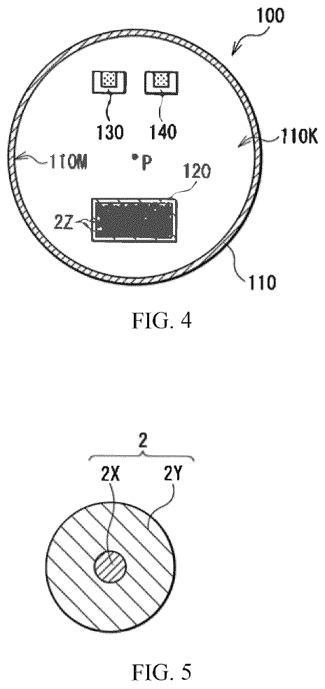

FIG. 4 illustrates a sectional configuration of a manufacturing apparatus 100 as an example of the manufacturing apparatus for the negative electrode active material 2. FIG. 5 illustrates a sectional configuration of the negative electrode active material 2 to be manufactured by the manufacturing apparatus 100 illustrated in FIG. 4.

The manufacturing apparatus 100 illustrated in FIG. 4 may be used to manufacture the negative electrode active material 2 illustrated in FIG. 5. In this case, a raw material particle 2X as a starting material may be used, and a deposited film 2Y may be formed on a surface of the raw material particle 2X to thereby form the negative electrode active material 2 including the raw material particle 2X and the deposited film 2Y.

For example, in the manufacturing apparatus 100, multiple raw material particles 2X may be used to thereby form the multiple negative electrode active materials 2. In the following, a description is given of a case where the multiple negative electrode active materials 2 are to be formed by the manufacturing apparatus 100.

For example, as illustrated in FIG. 4, the manufacturing apparatus 100 may include a rotator 110, a container 120, a first vapor-depositor 130, and a second vapor-depositor 140.

Although not illustrated here, the manufacturing apparatus 100 may be provided inside a vacuum container in which a vacuum level is adjustable. This allows the manufacturing apparatus 100 to manufacture the negative electrode active materials 2 in a vacuum environment.

The rotator 110 may be a tubular member having a through hole 110K. The rotator 110 may hold the raw material particles 2X upon formation of the deposited films 2Y. The rotator 110 may be rotatable about a rotational axis P. The rotator 110 may have an inner wall surface 110M that is used to hold the raw material particles 2X upon rotation. The rotational axis P may be a virtual axis extending in an extending direction of the through hole 110K.

The container 120 may be a box-shaped member that contains the raw material particles 2X. The container 120 may be spaced away from the inner wall surface 110M, and may be provided close to the inner wall surface 110M. The container 120 may further include a stirring mechanism to stir the raw material particles 2X. A portion, opposed to the inner wall surface 110M, of the container 120 may be openable and closable. This may allow the container 120 to contain the raw material particles 2X in a closed state and to discharge the raw material particles 2X toward the inner wall surface 110M in an open state.

The first vapor-depositor 130 may be a vapor-deposition source to be used to form the deposited film 2Y by a vapor-deposition method, and may include a first raw material and a heating mechanism. The first vapor-depositor 130 may be provided inside the through hole 110K. The first vapor-depositor 130 may be spaced away from the inner wall surface 110M, and may be provided close to the inner wall surface 110M. The heating mechanism of the first vapor-depositor 130 may heat the first raw material upon formation of the deposited film 2Y to thereby generate a gas for vapor-deposition, i.e., a vapor-deposition gas G1 illustrated in FIG. 7 to be described later.

Here, as described above, the manufacturing apparatus 100 may be provided inside the vacuum container. Accordingly, the first vapor-depositor 130 may perform a vapor-deposition process by a vacuum deposition method.

The first raw material may be different in kind from a second raw material to be described later. For example, the first raw material may include the simple substance of silicon, the silicon oxide, or both.

The second vapor-depositor 140 may be another vapor-deposition source to be used to form the deposited film 2Y by the vapor-deposition method, and may include the second raw material and a heating mechanism. The second vapor-depositor 140 may be provided inside the through hole 110K. The second vapor-depositor 140 here may be provided close to and next to the first vapor-depositor 130. The second vapor-depositor 140 may be spaced away from the inner wall surface 110M, and may be provided close to the inner wall surface 110M. The heating mechanism of the second vapor-depositor 140 may heat the second raw material upon the formation of the deposited film 2Y to thereby generate a gas for vapor-deposition, i.e., a vapor-deposition gas G2 illustrated in FIG. 7 to be described later.

Here, as described above, the manufacturing apparatus 100 may be provided inside the vacuum container. Accordingly, the second vapor-depositor 140 may perform a vapor-deposition process by the vacuum deposition method.

The second raw material may be different in kind from the first raw material. For example, the second raw material may include a metal material as a source of the metal element. Non-limiting examples of the metal material may include a simple substance of a metal.

For example, the heating mechanism of the second vapor-depositor 140 may be configured to change a heating temperature of the second raw material upon the formation of the deposited film 2Y, which makes it possible for the second vapor-depositor 140 to change an amount of the vapor-deposition gas G2 to be generated upon the formation of the deposited film 2Y. For example, the heating mechanism of the second vapor-depositor 140 may increase the heating temperature upon the formation of the deposited film 2Y, thus allowing the second vapor-depositor 140 to increase the amount of the vapor-deposition gas G2 to be generated.

Note that in an embodiment, the manufacturing apparatus 100 may further include any one or more of other components. Non-limiting examples of the other components may include a power supply, a control device, and a rotation mechanism.

The power supply may supply electric power to components including, without limitation, the control device, the rotation mechanism, the rotator 110, the first vapor-depositor 130, and the second vapor-depositor 140. The control device may be a device that controls an overall operation of the manufacturing apparatus 100. The control device may include, without limitation, a central processing unit (CPU). The rotation mechanism may be a mechanism that rotates the rotator 110. The rotation mechanism may include, without limitation, a motor.

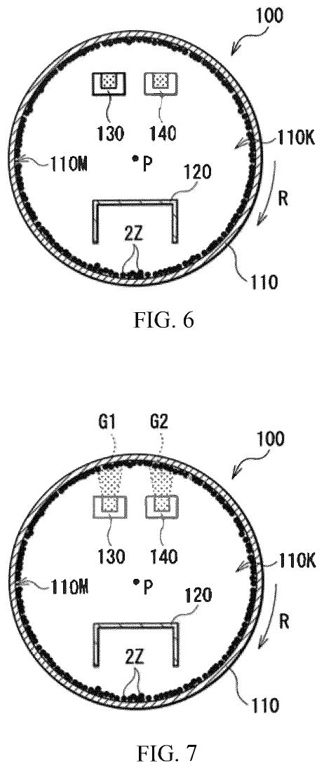

FIGS. 6 and 7 each illustrate a sectional configuration corresponding to that illustrated in FIG. 4 for describing a process of manufacturing the negative electrode active material 2. In the following, a description is given of the procedure for manufacturing the negative electrode active material 2 with a description of an operation of the manufacturing apparatus 100 with reference to FIGS. 4 and 5 together with FIGS. 6 and 7.

The rotator 110 may not be rotated yet in a state prior to start of manufacture of the negative electrode active material 2. Accordingly, the rotator 110 may remain stationary and the container 120 may be closed. Accordingly, the raw material particles 2X may be contained in the container 120.

The raw material particles 2X are not particularly limited in kind or composition. For example, the raw material particles 2X may include only the simple substance of silicon, or may include the simple substance of silicon and the silicon oxide.

When the multiple negative electrode active materials 2 are to be manufactured by the manufacturing apparatus 100, first, a pressure inside the vacuum container may be reduced to bring an inside of the through hole 110K into a vacuum environment. The pressure in the vacuum environment is not particularly limited, and may be set as desired.

Thereafter, as illustrated in FIG. 6, the rotator 110 may rotate about the rotational axis P in a rotation direction R. Here, the rotator 110 may rotate in a clockwise direction.

A rotation speed of the rotator 110 is not particularly limited as long as the rotation speed allows the inner wall surface 110M to hold the raw material particles 2X with use of centrifugal force generated by rotation of the rotator 110. Therefore, the rotation speed of the rotator 110 may be set as desired. For example, the rotation speed of the rotator 110 may be 150 rpm.

Thereafter, the container 120 may be opened in a state in which the inner wall surface 110M is allowed to hold the raw material particles 2X by the rotation of the rotator 110. This may cause the raw material particles 2X to be discharged from the container 120 toward the inner wall surface 110M, as illustrated in FIG. 6.

In this case, the inner wall surface 110M may be moved relatively with respect to the container 120 by the rotation of the rotator 110. Thus, the raw material particles 2X may be sequentially supplied to the entire inner wall surface 110M. Further, the raw material particles 110M may be pressed against the inner wall surface 110M with use of the centrifugal force generated by the rotation of the rotator 110, and the raw material particles 2X may thus be held on the inner wall surface 110M. The entire inner wall surface 110M may thus hold the raw material particles 2X.

Thereafter, as illustrated in FIG. 7, the first vapor-depositor 130 and the second vapor-depositor 140 may each perform the vapor-deposition process in a state in which the entire inner wall surface 110M is holding the raw material particles 2X.

For example, the first vapor-depositor 130 may heat the first raw material to thereby discharge the vapor-deposition gas G1 to the raw material particles 2X held by the inner wall surface 110M. A heating temperature of the first raw material is not particularly limited as long as the heating temperature allows for gasification of the first raw material, and may be set as desired. In this case, the raw material particles 2X may each rotate while being held by the inner wall surface 110M upon the rotation of the rotator 110. The vapor-deposition gas G1 may thus be discharged to the entire surface of each of the raw material particles 2X.

Further, the second vapor-depositor 140 may heat the second raw material to thereby discharge the vapor-deposition gas G2 to the raw material particles 2X held by the inner wall surface 110M. The heating temperature of the second raw material is not particularly limited as long as the heating temperature allows for gasification of the second raw material, and may be set as desired. In this case, as described above, the raw material particles 2X may each rotate while being held by the inner wall surface 110M. The vapor-deposition gas G2 may thus be discharged to the entire surface of each of the raw material particles 2X.

Thus, the vapor-deposition gases G1 and G2 may be discharged to the surface of each of the raw material particles 2X. As a result, the first raw material and the second raw material may be deposited on the surface of each of the raw material particles 2X.

Thus, as illustrated in FIG. 5, the deposited film 2Y may be formed on the surface of each of the raw material particles 2X. The deposited film 2Y may include both the first raw material and the second raw material. Accordingly, the deposited film 2Y may include the simple substance of silicon, the silicon oxide, or both, and may include the metal element.

For example, the second vapor-depositor 140 may increase the heating temperature of the second raw material depending on progress of the vapor-deposition process. An increasing speed of the heating temperature is not particularly limited, and may be set as desired. In this case, an amount of the vapor-deposition gas G2 to be discharged may increase in accordance with progress of the vapor-deposition process, and an amount of the metal element to be included in the deposited film 2Y may thus also increase. Accordingly, the content of the metal element in the deposited film 2Y may increase in a direction from the raw material particle 2X to the deposited film 2Y. In other words, the content of the metal element in the deposited film 2Y may decrease in a direction from the deposited film 2Y to the raw material particle 2X.

The multiple negative electrode active materials 2 each including the raw material particle 2X and the deposited film 2Y may thus be completed, as illustrated in FIG. 5.

When the multiple negative electrode active materials 2 are to be manufactured, a median diameter of the raw material particles 2X may be set as desired, and a formation amount, e.g., a thickness of the deposited film 2Y may be set as desired.

In an embodiment, when the raw material particles 2X do not include the metal silicate, in order to include the metal silicate not only in each of the middle part 2B and the surface part 2C but also in the center part 2A as illustrated in FIG. 2, the median diameter of the raw material particles 2X, the formation amount of the deposited film 2Y, or both may be adjusted.

In this case, firstly, in an embodiment, the median diameter of the raw material particles 2X may be adjusted to be sufficiently small, thus allowing the center part 2A to include not only the raw material particle 2X but also a portion of the deposited film 2Y. Secondly, in an embodiment, the formation amount of the deposited film 2Y may be adjusted to be sufficiently large, thus allowing the center part 2A to include not only the raw material particle 2X but also a portion of the deposited film 2Y. Thirdly, in an embodiment, the median diameter of the raw material particles 2X may be adjusted to be sufficiently small and the formation amount of the deposited film 2Y may be adjusted to be sufficiently large, thus allowing the center part 2A to include not only the raw material particle 2X but also a portion of the deposited film 2Y.

As a result, not only the middle part 2B and the surface part 2C but also the center part 2A may include the metal silicate, and the abundances CA, CB, and CC may thus satisfy the appropriate relationship of CC>CB>CA described above.

In some embodiment, as illustrated in FIG. 3, the film 3 may be formed on the surface of the negative electrode active material 2 after the negative electrode active material 2 is manufactured. In this case, a heating device such as a tube-type electric furnace may be used, and a carbon source such as methane may be used as a raw material. A thickness of the film 3 is not particularly limited, and may be set as desired.

First, the multiple negative electrode active materials 2, the negative electrode binder, and the negative electrode conductor may be mixed with each other to thereby obtain a negative electrode mixture.

Thereafter, the negative electrode mixture may be put into a solvent to thereby prepare a negative electrode mixture slurry in paste form. The solvent may be an aqueous solvent, or may be an organic solvent. Thereafter, the negative electrode mixture slurry may be applied on the two opposed surfaces of the negative electrode current collector 1A to thereby form the negative electrode active material layers 1B.

In an embodiment, the negative electrode active material layers 1B may be thereafter compression-molded by a compression device such as a roll pressing machine. In this case, in an embodiment, the negative electrode active material layers 1B may be heated. In an embodiment, the negative electrode active material layers 1B may be compression-molded multiple times.

The negative electrode active material layers 1B may thus be formed on the two respective opposed surfaces of the negative electrode current collector 1A. As a result, the negative electrode 1 may be completed.

According to the negative electrode 1, the negative electrode active material 2 includes the metal silicate. When the section of the negative electrode active material 2 is classified into the center part 2A, the middle part 2B, and the surface part 2C, the abundances CA, CB, and CC satisfy the appropriate relationship of CC>CB>CA.

In this case, the distribution of the metal element inside the negative electrode active material 2 is made appropriate as described above. This helps to decrease the reactivity in the vicinity of the surface of the negative electrode active material 2 and to improve the lithium insertability and lithium extractability in the vicinity of the center of the negative electrode active material 2. This helps to suppress the decomposition reaction of the electrolytic solution and to increase the battery capacity in the secondary battery including the negative electrode 1, which helps to achieve a secondary battery having a superior battery characteristic.

In an embodiment, the metal silicate may include any one or more of the first metal silicate, the second metal silicate, the third metal silicate, the fourth metal silicate, or the fifth metal silicate. This helps to sufficiently decrease the reactivity in the vicinity of the surface of the negative electrode active material 2 and to sufficiently improve the lithium insertability and lithium extractability in the vicinity of the center of the negative electrode active material 2, which helps to achieve higher effects.

In this case, in an embodiment, the metal silicate may include the first metal silicate. This helps to sufficiently decrease the reactivity in the vicinity of the surface of the negative electrode active material 2 and to sufficiently improve the lithium insertability and lithium extractability in the vicinity of the center of the negative electrode active material 2, which helps to achieve higher effects. In an embodiment, the first metal silicate may include magnesium as the alkaline earth metal element. This helps to further decrease the reactivity in the vicinity of the surface of the negative electrode active material 2 and to further improve the lithium insertability and lithium extractability in the vicinity of the center of the negative electrode active material 2, which helps to achieve markedly high effects.

In an embodiment, the metal content rate of the metal element in the metal silicate may be within the range from 1 mol % to 20 mol % both inclusive. This helps to sufficiently decrease the reactivity in the vicinity of the surface of the negative electrode active material 2 and to sufficiently improve the lithium insertability and lithium extractability in the vicinity of the center of the negative electrode active material 2, which helps to achieve higher effects.

In an embodiment, the oxygen-silicon ratio in the metal silicate may be within the range from 0.80 to 1.30 both inclusive. This helps to sufficiently decrease the reactivity in the vicinity of the surface of the negative electrode active material 2 and to sufficiently improve the lithium insertability and lithium extractability in the vicinity of the center of the negative electrode active material 2, which helps to achieve higher effects.

In an embodiment, the crystallite size of the Si(220) crystal plane may be less than or equal to 30 nm. This helps to sufficiently decrease the reactivity in the vicinity of the surface of the negative electrode active material 2 and to sufficiently improve the lithium insertability and lithium extractability in the vicinity of the center of the negative electrode active material 2, which helps to achieve higher effects.

In an embodiment, the negative electrode 1 may include the multiple negative electrode active materials 2, and the median diameter of the negative electrode active materials 2 may be within the range from 0.1 μm to 50 μm both inclusive. This helps to sufficiently decrease the reactivity in the vicinity of the surface of the negative electrode active material 2 and to sufficiently improve the lithium insertability and lithium extractability in the vicinity of the center of the negative electrode active material 2, which helps to achieve higher effects.

In an embodiment, the negative electrode active material 2 may further include the single substance of silicon and the silicon oxide. This helps to further decrease the reactivity in the vicinity of the surface of the negative electrode active material 2 and to further improve the lithium insertability and lithium extractability in the vicinity of the center of the negative electrode active material 2, which helps to achieve higher effects.

In this case, in an embodiment, x may satisfy 0.5≤x≤1.5 in Formula (6) that represents the configuration of the silicon oxide. This helps to further decrease the reactivity in the vicinity of the surface of the negative electrode active material 2 and to further improve the lithium insertability and lithium extractability in the vicinity of the center of the negative electrode active material 2, which helps to achieve markedly high effects.

A description is given next of a secondary battery according to an example embodiment of the present disclosure to which the negative electrode 1 described above is to be applied.

The secondary battery described here may be a secondary battery in which a battery capacity is obtained through insertion and extraction of an electrode reactant. The secondary battery includes a positive electrode, a negative electrode, and an electrolytic solution. Examples are given below of a case where the electrode reactant is lithium as described above. A secondary battery in which the battery capacity is obtained through insertion and extraction of lithium may be what is called a lithium secondary battery or a lithium-ion secondary battery. In the secondary battery, lithium may be inserted and extracted in an ionic state.

In an embodiment, a charge capacity of the negative electrode may be greater than a discharge capacity of the positive electrode. For example, an electrochemical capacity per unit area of the negative electrode may be greater than an electrochemical capacity per unit area of the positive electrode. One reason for this is to prevent precipitation of lithium on a surface of the negative electrode during charging.

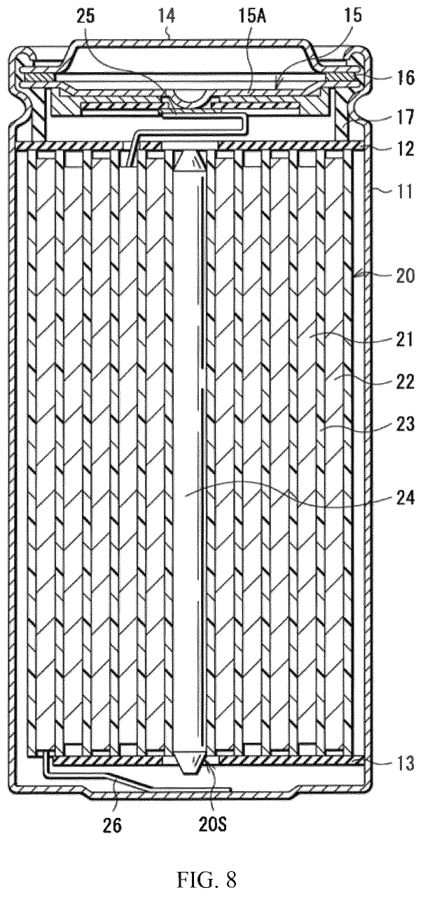

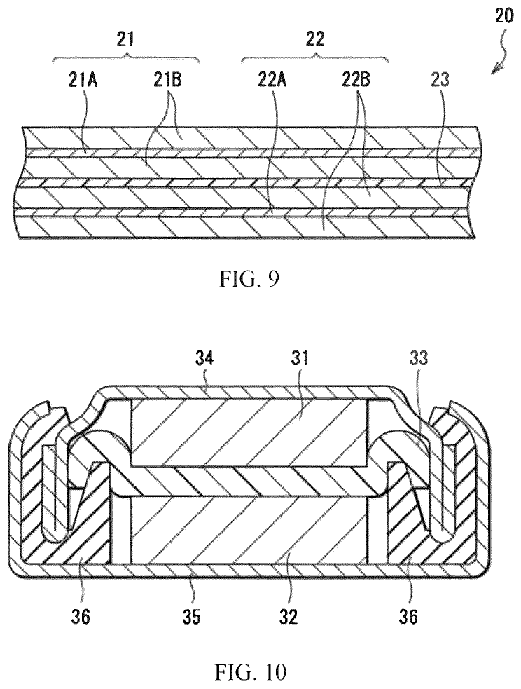

FIG. 8 illustrates a sectional configuration of the secondary battery. FIG. 9 illustrates a sectional configuration of a battery device 20 illustrated in FIG. 8.

As illustrated in FIGS. 8 and 9, the secondary battery may include a battery can 11, a pair of insulating plates 12 and 13, the battery device 20, a positive electrode lead 25, and a negative electrode lead 26. The secondary battery described here may be a secondary battery of a cylindrical type in which the battery device 20 is contained in the battery can 11 having a cylindrical shape.

As illustrated in FIG. 8, the battery can 11 may be a member that contains the battery device 20 and other components. The battery can 11 may have one end part that is open and another end part that is closed, and may thus have a hollow structure. Further, the battery can 11 may include any one or more of metal materials including, without limitation, iron, aluminum, an iron alloy, and an aluminum alloy. In an embodiment, the battery can 11 may have a surface plated with a metal material such as nickel.

A battery cover 14, a safety valve mechanism 15, and a positive temperature coefficient (PTC) device 16 may be crimped at the open end part of the battery can 11 by a gasket 17. The battery can 11 may thus be sealed by the battery cover 14. Here, the battery cover 14 may include a material similar to the material included in the battery can 11. The PTC device 16 may be a thermosensitive resistive device. The safety valve mechanism 15 and the PTC device 16 may each be disposed on an inner side of the battery cover 14. The safety valve mechanism 15 may be electrically coupled to the battery cover 14 via the PTC device 16. The gasket 17 may include an insulating material. In an embodiment, a surface of the gasket 17 may be coated with a material such as asphalt.

In the safety valve mechanism 15, a disk plate 15A may invert when an internal pressure of the battery can 11 reaches a certain level or higher due to an event such as an internal short circuit or heating from outside, thereby cutting off the electrical coupling between the battery cover 14 and the battery device 20. An electric resistance of the PTC device 16 may increase in accordance with a rise in temperature, in order to prevent abnormal heat generation resulting from a large current.

As illustrated in FIG. 8, the insulating plates 12 and 13 may be so provided as to be opposed to each other with the battery device 20 interposed therebetween. The battery device 20 may thereby be sandwiched between the insulating plates 12 and 13.

The battery device 20 may be what is called a power generation device, and may include, as illustrated in FIGS. 8 and 9, a positive electrode 21, a negative electrode 22, a separator 23, and the unillustrated electrolytic solution.

The battery device 20 may be what is called a wound electrode body, and the positive electrode 21 and the negative electrode 22 may thus be wound, being opposed to each other with the separator 23 interposed therebetween. A center pin 24 may be disposed in a space 20S provided at a winding center of the battery device 20. However, in an embodiment, the center pin 24 may be omitted.

The positive electrode 21 may include, as illustrated in FIGS. 8 and 9, a positive electrode current collector 21A and a positive electrode active material layer 21B. In an embodiment, the positive electrode current collector 21A may be omitted.

The positive electrode current collector 21A may have two opposed surfaces on each of which the positive electrode active material layer 21B is to be provided. The positive electrode current collector 21A may include an electrically conductive material such as a metal material. Non-limiting examples of the electrically conductive material may include aluminum.

The positive electrode active material layer 21B may include any one or more of positive electrode active materials into which lithium is to be inserted and from which lithium is to be extracted. In an embodiment, the positive electrode active material layer 21B may further include any one or more of other materials including, without limitation, a positive electrode binder and a positive electrode conductor. A method of forming the positive electrode active material layer 21B is not particularly limited, and may be, for example, a method such as a coating method.

Here, the positive electrode active material layer 21B may be provided on each of the two opposed surfaces of the positive electrode current collector 21A. In an embodiment, the positive electrode active material layer 21B may be provided only on one of the two opposed surfaces of the positive electrode current collector 21, on a side where the positive electrode 21 is opposed to the negative electrode 22.

The positive electrode active material is not particularly limited in kind, and non-limiting examples of the positive electrode active material may include a lithium-containing compound. The lithium-containing compound may be a compound that includes lithium and any one or more of transition metal elements as constituent elements. In some embodiment, the lithium-containing compound may further include any one or more of other elements as one or more constituent elements. The one or more other elements are not particularly limited in kind as long as the one or more other elements are each an element other than lithium and the transition metal elements. For example, the one or more other elements may be any one or more of elements belonging to groups 2 to 15 in the long period periodic table. The lithium-containing compound is not particularly limited in kind, and the lithium-containing compound may be, for example but not limited to, an oxide, a phosphoric acid compound, a silicic acid compound, a boric acid compound, or any other compound.

Non-limiting examples of the oxide may include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Non-limiting examples of the phosphoric acid compound may include LiFePO₄, LiMnPO₄, LiFe_{0.5}Mn_{0.5}PO₄, and LiFe_{0.3}Mn_{0.7}PO₄.

The positive electrode binder may include any one or more of materials including, without limitation, a synthetic rubber and a polymer compound. Non-limiting examples of the synthetic rubber may include a styrene-butadiene-based rubber, a fluorine-based rubber, and ethylene propylene diene. Non-limiting examples of the polymer compound may include polyvinylidene difluoride, polyimide, and carboxymethyl cellulose.

The positive electrode conductor may include any one or more of electrically conductive materials including, without limitation, a carbon material, a metal material, and an electrically conductive polymer compound. Non-limiting examples of the carbon material may include graphite, carbon black, acetylene black, and Ketjen black.

The negative electrode 22 has a configuration similar to the configuration of the negative electrode 1, as illustrated in FIGS. 8 and 9.

For example, the negative electrode 22 may include a negative electrode current collector 22A and a negative electrode active material layer 22B. The negative electrode current collector 22A may have a configuration similar to the configuration of the negative electrode current collector 1A. The negative electrode active material layer 22B may have a configuration similar to the configuration of the negative electrode active material layer 1B. Here, the negative electrode active material layer 22B may be provided on each of two opposed surfaces of the negative electrode current collector 22A. In an embodiment, the negative electrode active material layer 22B may be provided only on one of the two opposed surfaces of the negative electrode current collector 22A on a side where the negative electrode 22 is opposed to the positive electrode 21.

The separator 23 may be an insulating porous film interposed between the positive electrode 21 and the negative electrode 22 as illustrated in FIGS. 8 and 9, and may allow lithium to pass therethrough in an ionic state while preventing occurrence of a short circuit caused by contact between the positive electrode 21 and the negative electrode 22. The separator 23 may include a polymer compound such as polyethylene.

The electrolytic solution may be a liquid electrolyte. The positive electrode 21, the negative electrode 22, and the separator 23 may each be impregnated with the electrolytic solution. The electrolytic solution may include a solvent and an electrolyte salt.

The solvent may include any one or more of nonaqueous solvents (organic solvents). The electrolytic solution including the one or more nonaqueous solvents may be what is called a nonaqueous electrolytic solution.

The nonaqueous solvent may be an ester or an ether, for example. For example, the nonaqueous solvent may be a carbonic-acid-ester-based compound, a carboxylic-acid-ester-based compound, or a lactone-based compound. One reason for this is that this helps to improve a dissociation property of the electrolyte salt and mobility of ions.

The carbonic-acid-ester-based compound may be a cyclic carbonic acid ester or a chain carbonic acid ester, for example. Non-limiting examples of the cyclic carbonic acid ester may include ethylene carbonate and propylene carbonate. Non-limiting examples of the chain carbonic acid ester may include dimethyl carbonate, diethyl carbonate, and ethyl methyl carbonate.

The carboxylic-acid-ester-based compound may be a chain carboxylic acid ester, for example. Non-limiting examples of the chain carboxylic acid ester may include ethyl acetate, ethyl propionate, propyl propionate, and ethyl trimethylacetate.

The lactone-based compound may be a lactone, for example. Non-limiting examples of the lactone may include γ-butyrolactone and γ-valerolactone.

In an embodiment, the ether may be 1,2-dimethoxyethane, tetrahydrofuran, 1,3-dioxolane, or 1,4-dioxane, for example.

In an embodiment, the nonaqueous solvent may be an unsaturated cyclic carbonic acid ester, a fluorinated cyclic carbonic acid ester, a sulfonic acid ester, a phosphoric acid ester, an acid anhydride, a nitrile compound, or an isocyanate compound, for example. One reason for this is that this helps to improve electrochemical stability of the electrolytic solution.

Non-limiting examples of the unsaturated cyclic carbonic acid ester may include vinylene carbonate, vinyl ethylene carbonate, and methylene ethylene carbonate. Non-limiting examples of the fluorinated cyclic carbonic acid ester may include monofluoroethylene carbonate and difluoroethylene carbonate. Non-limiting examples of the sulfonic acid ester may include propane sultone and propene sultone. Non-limiting examples of the phosphoric acid ester may include trimethyl phosphate and triethyl phosphate. Non-limiting examples of the acid anhydride may include succinic anhydride, 1,2-ethanedisulfonic anhydride, and 2-sulfobenzoic anhydride. Non-limiting examples of the nitrile compound may include succinonitrile. Non-limiting examples of the isocyanate compound may include hexamethylene diisocyanate.

The electrolyte salt may include any one or more of light metal salts including, without limitation, a lithium salt.

Non-limiting examples of the lithium salt may include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). One reason for this is that this helps to obtain a high battery capacity.

A content of the electrolyte salt is not particularly limited, and may be, for example, within a range from 0.3 mol/kg to 3.0 mol/kg both inclusive with respect to the solvent. One reason for this is that this helps to obtain high ion conductivity.

As illustrated in FIG. 8, the positive electrode lead 25 may be coupled to the positive electrode current collector 21A, and may include an electrically conductive material such as aluminum. The positive electrode lead 25 may be electrically coupled to the battery cover 14 via the safety valve mechanism 15.

As illustrated in FIG. 8, the negative electrode lead 26 may be coupled to the negative electrode current collector 22A, and may include an electrically conductive material such as nickel. The negative electrode lead 26 may be electrically coupled to the battery can 11.

The secondary battery may operate as below upon charging and discharging.

Upon charging, in the battery device 20, lithium may be extracted from the positive electrode 21, and the extracted lithium may be inserted into the negative electrode 22 via the electrolytic solution. Upon discharging, in the battery device 20, lithium may be extracted from the negative electrode 22, and the extracted lithium may be inserted into the positive electrode 21 via the electrolytic solution. Upon charging and discharging, lithium may be inserted and extracted in an ionic state.

When the secondary battery is to be manufactured, the positive electrode 21 and the negative electrode 22 may be fabricated and the electrolytic solution may be prepared, following which the secondary battery may be assembled and a stabilization process of the assembled secondary battery may be performed, according to an example procedure described below.

First, the positive electrode active material, the positive electrode binder, and the positive electrode conductor may be mixed with each other to thereby obtain a positive electrode mixture. Thereafter, the positive electrode mixture may be put into a solvent to thereby prepare a positive electrode mixture slurry in paste form. The solvent may be an aqueous solvent, or may be an organic solvent. Thereafter, the positive electrode mixture slurry may be applied on the two respective opposed surfaces of the positive electrode current collector 21A to thereby form the positive electrode active material layers 21B. Thereafter, the positive electrode active material layers 21B may be compression-molded by a compression device such as a roll pressing machine. In this case, in an embodiment, the positive electrode active material layers 21B may be heated. In an embodiment, the positive electrode active material layers 21B may be compression-molded multiple times. The positive electrode active material layers 21B may thus be formed on the two respective opposed surfaces of the positive electrode current collector 21A. As a result, the positive electrode 21 may be fabricated.

The negative electrode active material layers 22B may be formed on the respective two opposed surfaces of the negative electrode current collector 22A by a procedure similar to the procedure for fabricating the negative electrode 1 described above to thereby fabricate the negative electrode 22.

The electrolyte salt may be put into the solvent. The electrolyte salt may thereby be dispersed or dissolved in the solvent. As a result, the electrolytic solution may be prepared.

First, the positive electrode lead 25 may be coupled to the positive electrode current collector 21A of the positive electrode 21 by a joining method such as a welding method, and the negative electrode lead 26 may be coupled to the negative electrode current collector 22A of the negative electrode 22 by a joining method such as the welding method.

Thereafter, the positive electrode 21 and the negative electrode 22 may be stacked on each other with the separator 23 interposed therebetween, following which the stack of the positive electrode 21, the negative electrode 22, and the separator 23 may be wound to thereby fabricate an unillustrated wound body having the space 20S. The wound body may have a configuration similar to that of the battery device 20 except that the positive electrode 21, the negative electrode 22, and the separator 23 are each not impregnated with the electrolytic solution. Thereafter, the center pin 24 may be placed in the space 20S.

Thereafter, the wound body may be sandwiched between the insulating plates 12 and 13, and in that state, the wound body and the insulating plates 12 and 13 may be placed in the battery can 11. In this case, the positive electrode lead 25 may be coupled to the safety valve mechanism 15 by a joining method such as the welding method, and the negative electrode lead 26 may be coupled to the battery can 11 by a joining method such as the welding method. Thereafter, the electrolytic solution may be injected into the battery can 11 to thereby impregnate the wound body with the electrolytic solution. Thus, the positive electrode 21, the negative electrode 22, and the separator 23 may each be impregnated with the electrolytic solution, and the battery device 20 may thereby be fabricated.

Thereafter, the battery cover 14, the safety valve mechanism 15, and the PTC device 16 may be placed in the battery can 11, following which the battery can 11 may be crimped by the gasket 17.

Thus, the battery cover 14, the safety valve mechanism 15, and the PTC device 16 may be fixed to the battery can 11, and the battery device 20 may be sealed in the battery can 11. As a result, the secondary battery may be assembled.

The assembled secondary battery may be charged and discharged. Various conditions including, without limitation, an environment temperature, the number of times of charging and discharging, i.e., the number of cycles, and charging and discharging conditions may be set as desired. A film may thereby be formed on the surface of each of the positive electrode 21 and the negative electrode 22. This may electrochemically stabilize a state of the battery device 20. The secondary battery may thus be completed.

The secondary battery includes the negative electrode 22 having a configuration similar to the configuration of the negative electrode 1. This helps to suppress the decomposition reaction of the electrolytic solution and to increase the battery capacity, thus helping to achieve a superior battery characteristic for the reason described above.

In an embodiment, the secondary battery may include a lithium secondary battery. This helps to obtain a sufficient battery capacity stably through insertion and extraction of lithium, which helps to achieve higher effects.

Other action and effects of the secondary battery may be similar to those of the negative electrode 1.

The configuration of the secondary battery may be appropriately modifiable including as described below according to an embodiment. In an embodiment, any two or more of the following series of modification examples may be combined with each other.

The separator 23 that is a porous film may be used. However, although not specifically illustrated here, in an embodiment, a separator of a stacked type including a polymer compound layer may be used.

For example, the separator of the stacked type may include a porous film having two opposed surfaces, and the polymer compound layer provided on one of or each of the two opposed surfaces of the porous film. One reason for this is that this helps to improve adherence of the separator to each of the positive electrode 21 and the negative electrode 22, thus suppressing misalignment of the battery device 20. This helps to suppress winding displacement of each of the positive electrode 21, the negative electrode 22, and the separator, which helps to suppress swelling of the secondary battery even if the decomposition reaction of the electrolytic solution occurs. The polymer compound layer may include, for example, polyvinylidene difluoride. One reason for this is that polyvinylidene difluoride is superior in physical strength and is electrochemically stable.

In an embodiment, the porous film, the polymer compound layer, or both may each include any one or more kinds of insulating particles. One reason for this is that the insulating particles dissipate heat upon heat generation by the secondary battery, thus helping to improve safety or heat resistance of the secondary battery. The insulating particles may include any one or more of insulating materials including, without limitation, an inorganic material and a resin material. Non-limiting examples of the inorganic material may include aluminum oxide, aluminum nitride, bochmite, silicon oxide, titanium oxide, magnesium oxide, and zirconium oxide. Non-limiting examples of the resin material may include acrylic resin and styrene resin.

When the separator of the stacked type is to be fabricated, a precursor solution including a polymer compound and an organic solvent may be prepared, following which the precursor solution may be applied on one of or each of the two opposed surfaces of the porous film. In this case, in an embodiment, the precursor solution may include the insulating particles.

When the separator of the stacked type is used also, lithium may be movable between the positive electrode 21 and the negative electrode 22 in an ionic state. This helps to achieve similar effects. In this case, for example, swelling of the secondary battery is further suppressed as described above, which helps to achieve higher effects.

The electrolytic solution, which is a liquid electrolyte, may be used. In an embodiment, although not specifically illustrated here, an electrolyte layer, which is a gel electrolyte, may be used.

In the battery device 20 including the electrolyte layer, the positive electrode 21 and the negative electrode 22 may be wound, being opposed to each other with the separator 23 and the electrolyte layer interposed therebetween. The electrolyte layer may be interposed between the positive electrode 21 and the separator 23, and between the negative electrode 22 and the separator 23.

For example, the electrolyte layer may include a polymer compound together with the electrolytic solution. The electrolytic solution may be held by the polymer compound. One reason for this is that this helps to prevent leakage of the electrolytic solution. The configuration of the electrolytic solution may be as described above. The polymer compound may include, for example, polyvinylidene difluoride. When the electrolyte layer is to be formed, a precursor solution including the electrolytic solution, the polymer compound, and a solvent may be prepared, following which the precursor solution may be applied on one side or both sides of the positive electrode 21 and on one side or both sides of the negative electrode 22.

When the electrolyte layer is used also, a lithium ion may be movable between the positive electrode 21 and the negative electrode 22 via the electrolyte layer. This helps to achieve similar effects. In this case, for example, the leakage of the electrolytic solution is prevented, as described above. This helps to achieve higher effects.

Hereinafter, a description is given of applications (application examples) of the secondary battery according to an embodiment.

The applications of the secondary battery are not particularly limited. The secondary battery used as a power source may serve as a main power source or an auxiliary power source in, for example but not limited to, electronic equipment, an electric vehicle, or any other application in which any embodiment of the present disclosure is usable. The main power source may be preferentially used regardless of the presence of any other power source. The auxiliary power source may be used in place of the main power source, or may be switched from the main power source.

Non-limiting examples of the applications of the secondary battery may include: electronic equipment; apparatuses for data storage; electric power tools; battery packs to be mounted on, for example but not limited to, electronic equipment; medical electronic equipment; electric vehicles; and electric power storage systems. Non-limiting examples of the electronic equipment may include video cameras, digital still cameras, mobile phones, laptop personal computers, headphone stereos, portable radios, portable information terminals, and any other electronic equipment to which any embodiment of the present disclosure is applicable. Non-limiting examples of the apparatuses for data storage may include backup power sources, memory cards, and any other apparatus for data storage to which any embodiment of the present disclosure is applicable. Non-limiting examples of the electric power tools may include electric drills, electric saws, and any other electric power tool to which any embodiment of the present disclosure is applicable. Non-limiting examples of the medical electronic equipment may include pacemakers, hearing aids, and any other medical electronic equipment to which any embodiment of the present disclosure is applicable. Non-limiting examples of the electric vehicles may include electric automobiles including hybrid automobiles, and any other electric vehicle to which any embodiment of the present disclosure is applicable. Non-limiting examples of the electric power storage systems may include battery systems for home use or industrial use in which electric power is accumulated for a situation such as emergency, and any other electric power storage system to which any embodiment of the present disclosure is applicable. In each of the above-described applications, one secondary battery may be used, or multiple secondary batteries may be used.

The battery packs may each include a battery cell, or may each include an assembled battery. In an embodiment, the electric vehicle may be a vehicle that travels with the secondary battery as a driving power source, and may be a hybrid automobile that is additionally provided with a driving source other than the secondary battery. In the electric power storage system for home use, electric power accumulated in the secondary battery serving as an electric power storage source may be utilized for using, for example but not limited to, home appliances and any other electrical appliance.

### EXAMPLES

A description is given of Examples of an example embodiment of the present disclosure. [Examples 1 to 24 and Comparative Examples 1 to 3]

The negative electrode active materials 2 were fabricated, and secondary batteries were fabricated using the negative electrode active materials 2, following which the secondary batteries were each evaluated for a battery characteristic as described below.

### [Fabrication of Negative Electrode Active Material]

Here, multiple negative electrode active materials 2 were fabricated by the manufacturing apparatus 100 illustrated in FIG. 4.

As the raw material particles 2X, 10 kg of a silicon compound (SiO) in powder form was used. The silicon compound in powder form had a median diameter of 1 μm. As a first raw material, 100 kg of a mixture of the simple substance of silicon (Si) having a purity of 99.9% in powder form and silicon oxide (SiO) in powder form was used. In this case, a mixture ratio, i.e., a mole ratio between the simple substance of silicon and the silicon oxide was set to 50:50. As a second raw material, 100 kg of a simple substance of magnesium (Mg) having a purity of 99.9% was used.

When the multiple negative electrode active materials 2 were to be manufactured, first, a pressure inside the through hole 110K was reduced to 0.1 torr, i.e., about 13.3322 Pa, following which the rotator 110 was rotated about the rotational axis P in a clockwise direction at a rotational speed of 150 rpm. Thereafter, the raw material particles 2X were discharged from the container 120 toward the inner wall surface 110M in a state in which the rotator 110 was rotating.

Thereafter, the vapor-deposition process was performed by each of the first vapor-depositor 130 and the second vapor-depositor 140, in a state in which the raw material particles 2X were held by the inner wall surface 110M. In this case, in the first vapor-depositor 130, the heating temperature of the first raw material was set to 1450° C. In the second vapor-depositor 140, the heating temperature of the second raw material was increased to 650° C. Thereafter, the heating temperature was increased to 700° C. after the lapse of 5 hours, and was further increased to 750° C. after the lapse of another 5 hours.

The deposited film 2Y was thus formed on the surface of each of the raw material particles 2X. As a result, the multiple negative electrode active materials 2 were fabricated. In this case, the heating temperature was increased in the second vapor-depositor 140 as described above. Thus, the abundance of the metal element decreased in the direction from the surface of the negative electrode active material 2 to the center of the negative electrode active material 2.

Lastly, the multiple negative electrode active materials 2 were put into a tube-type electric furnace. Thereafter, the multiple negative electrode active materials 2 were stirred while a methane gas and an argon gas were supplied to an inside of the tube-type electric furnace at a supply rate of 1 L/min (=1 dm³/min) and the multiple negative electrode active materials 2 were heated at a heating temperature of 1000° C. for a heating time of 1 hour. Thus, the film 3 including a carbon material was formed on the surface of each of the negative electrode active materials 2.

The multiple negative electrode active materials 2 each provided with the film 3 were thus completed (Examples 1 to 20). The negative electrode active materials 2 included the simple substance of silicon and the silicon oxide together with MgₐSiO_{b} as a metal silicate, i.e., a first metal silicate. Specifically, MgₐSiO_{b} included MgSiO₃, Mg₂SiO₄, or both.

Hereinafter, for simplifying the description, the multiple negative electrode active materials 2 each provided with the film 3 are simply referred to as the “multiple negative electrode active materials 2”, and the negative electrode active material 2 provided with the film 3 is simply referred to as the “negative electrode active material 2”.

When the multiple negative electrode active materials 2 were to be fabricated, the configuration of the multiple negative electrode active materials 2 was changed as listed in Tables 1 and 2.

An abundance rate (mol %) and oxygen-silicon ratio were each changed by changing conditions including, without limitation, a used amount of the second raw material and the heating temperature of the second raw material. After completion of the multiple negative electrode active materials 2, a crystallite size (nm) was changed by additionally heating the multiple negative electrode active materials 2 and changing the temperature upon the heating. A median diameter (μm) was changed by changing a deposited amount of the deposited film 2Y depending on change in conditions including, without limitations, a deposition time in each of the first vapor-depositor 130 and the second vapor-depositor 140.

After the completion of the multiple negative electrode active materials 2, the abundances CA, CB, and CC were each calculated, and a relationship among the abundances CA, CB, and CC was examined, thereby obtaining results entered in a “Relationship among abundances (CA, CB, CC)” column of each of Tables 1 and 2. In the column, “CC>CB>CA” indicates that the abundance CC was greater than the abundance CB and the abundance CB was greater than the abundance CA. The procedure for calculating the abundances CA, CB, and CC was as described above.

For comparison, the multiple negative electrode active materials 2 were fabricated by a similar procedure except that the second vapor-depositor 140 was not used and only the first vapor-depositor 130 was used (Comparative example 1).

Further, for comparison, the multiple negative electrode active materials 2 were fabricated by a similar procedure except that the heating temperature of the second raw material was not increased (Comparative example 2). In this case, the “Relationship among abundances (CA, CB, CC)” was “CC=CB=CA”. Accordingly, the abundances CA, CB, and CC were equal to each other.

### [Fabrication of Secondary Battery]

A secondary battery for testing was fabricated here for simple evaluation of the battery characteristic. FIG. 10 illustrates a sectional configuration of the secondary battery for testing. The secondary battery for testing was a lithium metal secondary battery of a coin type.

Hereinafter, a description is given first of a configuration of the secondary battery for testing, and thereafter of a procedure for fabricating the secondary battery for testing.

### [Configuration of Secondary Battery for Testing]

As illustrated in FIG. 10, the secondary battery for testing included a test electrode 31, a counter electrode 32, a separator 33, an outer package cup 34, an outer package can 35, a gasket 36, and an unillustrated electrolytic solution.

The test electrode 31 was placed in the outer package cup 34 in a bowl shape, and the counter electrode 32 was placed inside the outer package can 35 in a bowl shape. The test electrode 31 and the counter electrode 32 were stacked on each other with the separator 33 interposed therebetween, and the test electrode 31, the counter electrode 32, and the separator 33 were each impregnated with the electrolytic solution. The outer package cup 34 was contained in the outer package can 35, and the outer package cup 34 and the outer package can 35 were crimped to each other by the gasket 36. Thus, the test electrode 31, the counter electrode 32, and the separator 33 were sealed in the outer package cup 34 and the outer package can 35.

### [Procedure for Fabricating Secondary Battery for Testing]

The procedure for fabricating the secondary battery for testing was as described below. Hereinafter, the multiple negative electrode active materials 2 described above are simply referred to as a “negative electrode active material”.

### [Fabrication of Test Electrode]

First, 9.6 g of the negative electrode active material, 1.2 g of a negative electrode binder (polyacrylamide), and 1.2 g of a negative electrode conductor (carbon black) were mixed with each other to thereby obtain a negative electrode mixture.

Thereafter, 38 g of a solvent (ion-exchanged water as an aqueous solvent) was put into a plastic container with a volume of 150 ml (=150 cm³), following which the negative electrode mixture was put into the solvent. Thereafter, the solvent was stirred at a stirring speed of 2000 rpm for a stirring time of 5 minutes by a planetary centrifugal mixer to thereby prepare a negative electrode mixture slurry.

Thereafter, the negative electrode mixture slurry was applied on one surface of a negative electrode current collector (a copper foil having a thickness of 10 μm) by a coating apparatus, following which the applied negative electrode mixture slurry was dried at a drying temperature of 100° C. for a drying time of 10 minutes to thereby form a negative electrode active material layer. Thereafter, the negative electrode active material layer was compression-molded by a pressing machine.

Lastly, the negative electrode current collector provided with the negative electrode active material layer was punched into a disk shape having a diameter of 15 mm. The test electrode 31 was thus fabricated.

### [Fabrication of Counter Electrode]

A lithium metal plate was punched into a disk shape having a diameter of 16 mm. The counter electrode 32 was thus fabricated.

### [Preparation of Electrolytic Solution]

An electrolyte salt (lithium hexafluorophosphate) was put into a solvent, following which the solvent was stirred.

Used as the solvent was a mixture of ethylene carbonate as a cyclic carbonic acid ester, dimethyl carbonate as a chain carbonic acid ester, and monofluoroethylene carbonate as a fluorinated cyclic carbonic acid ester. In this case, a mixture ratio, i.e., a mass ratio, among the cyclic carbonic acid ester, the chain carbonic acid ester, and the fluorinated cyclic carbonic acid ester was set to 40:50:10.

As a result, the electrolytic solution was prepared. In this case, a content of the electrolyte salt in the electrolytic solution was 1 mol/kg with respect to the solvent.

### [Assembly of Secondary Battery for Testing]

First, the test electrode 31 was placed in the outer package cup 34, and the counter electrode 32 was placed in the outer package can 35. Thereafter, the test electrode 31 placed in the outer package cup 34 and the counter electrode 32 placed in the outer package can 35 were stacked on each other with the separator 33 (polyethylene) having a thickness of 20 μm interposed therebetween. The separator 33 was impregnated with the electrolytic solution. In this case, the test electrode 31 was placed to cause the negative electrode active material layer provided on the one surface of the negative electrode current collector to be opposed to the counter electrode 32 with the separator 33 interposed therebetween. Lastly, the outer package cup 34 and the outer package can 35 were crimped to each other by the gasket 36 (a resin material) having a thickness of 500 μm in a state in which the test electrode 31 and the counter electrode 32 were stacked on each other with the separator 33 interposed therebetween. The test electrode 31 and the counter electrode 32 were thus sealed in the outer package cup 34 and the outer package can 35. As a result, the secondary battery for testing was completed.

### [Evaluation of Battery Characteristic]

Evaluation of the secondary batteries for a capacity characteristic, an initial charge and discharge characteristic, and a cyclability characteristic as the battery characteristic revealed the results presented in Tables 1 and 2.

### [Capacity Characteristic]

When the capacity characteristic was to be evaluated, the secondary battery was charged and discharged in an ambient temperature environment at a temperature of 23° C. to thereby measure a discharge capacity (mAh). Thereafter, the discharge capacity was divided by a weight (g) of the negative electrode active material to thereby calculate a battery capacity (mAh/g) used as an index for evaluating the capacity characteristic.

Upon charging, the secondary battery was charged with a constant current at a current density of 0.2 mA/cm² until a voltage reached 0 V, and was thereafter charged with a constant voltage of that value, 0 V, until a current reached 0.04 mA. Upon discharging, the secondary battery was discharged with a constant current at a current density of 0.2 mA/cm² until the voltage reached 1.5 V.

### [Initial Charge and Discharge Characteristic]

When the initial charge and discharge characteristic was to be evaluated, first, the secondary battery was charged in an ambient temperature environment at a temperature of 23° C. to thereby measure a charge capacity (mAh). Thereafter, the secondary battery was discharged in the same environment to thereby measure a discharge capacity (mAh). Thereafter, initial efficiency (%) used as an index for evaluating the initial charge and discharge characteristic was calculated based on the following calculation expression: initial efficiency=(discharge capacity/charge capacity)×100. Note that charging and discharging conditions were similar to the charging and discharging conditions for the evaluation of the capacity characteristic.

### [Cyclability Characteristic]

When the cyclability characteristic was to be evaluated, first, the secondary battery was charged and discharged in an ambient temperature environment at a temperature of 23° C. to thereby measure a first-cycle discharge capacity (mAh). Thereafter, the secondary battery was repeatedly charged and discharged in the same environment until the total number of cycles reached 400 to thereby measure a 400th-cycle discharge capacity (mAh). Lastly, a capacity retention rate (%) used as an index for evaluating the cyclability characteristic was calculated based on the following calculation expression: capacity retention rate=(400th-cycle discharge capacity/first-cycle discharge capacity)×100.

Upon charging, the secondary battery was charged with a constant current at a current density of 0.5 mA/cm² until a voltage reached 0 V, and was thereafter charged with a constant voltage of that value, 0 V, until a current reached 0.05 mA. Upon discharging, the secondary battery was discharged with a constant current at a current density of 0.5 mA/cm² until the voltage reached 1.5 V.

TABLE 1

| | Negative electrode | | Relationship | | | | | | | Capacity |
|---|---|---|---|---|---|---|---|---|---|---|
| | active material | | among | Abundance | | Crystallite | Median | Battery | Initial | retention |
| | Metal | | abundances | rate | Content | size | diameter | capacity | efficiency | rate |
| | silicate | Others | (CA, CB, CC) | (mol %) | ratio | (nm) | (μm) | (mAh/g) | (%) | (%) |
| Example 1 | MgₐSiO_{b} | Si + SiO | CC > CB > CA | 0.5 | 1.00 | 6 | 5 | 1447.8 | 79.2 | 71.9 |
| Example 2 | MgₐSiO_{b} | Si + SiO | CC > CB > CA | 1 | 1.00 | 6 | 5 | 1446.5 | 80.9 | 83.2 |
| Example 3 | MgₐSiO_{b} | Si + SiO | CC > CB > CA | 8 | 1.00 | 6 | 5 | 1443.9 | 84.1 | 86.1 |
| Example 4 | MgₐSiO_{b} | Si + SiO | CC > CB > CA | 10 | 1.00 | 6 | 5 | 1431.2 | 85.8 | 88.6 |
| Example 5 | MgₐSiO_{b} | Si + SiO | CC > CB > CA | 12 | 1.00 | 6 | 5 | 1402.9 | 87.0 | 87.3 |
| Example 6 | MgₐSiO_{b} | Si + SiO | CC > CB > CA | 15 | 1.00 | 6 | 5 | 1255.7 | 88.3 | 85.0 |
| Example 7 | MgₐSiO_{b} | Si + SiO | CC > CB > CA | 20 | 1.00 | 6 | 5 | 1149.4 | 87.1 | 83.4 |
| Example 8 | MgₐSiO_{b} | Si + SiO | CC > CB > CA | 25 | 1.00 | 6 | 5 | 925.8 | 77.6 | 70.5 |
| Example 9 | MgₐSiO_{b} | Si + SiO | CC > CB > CA | 10 | 0.70 | 6 | 5 | 1746.8 | 98.1 | 75.6 |
| Example 10 | MgₐSiO_{b} | Si + SiO | CC > CB > CA | 10 | 0.80 | 6 | 5 | 1520.5 | 93.2 | 82.9 |
| Example 11 | MgₐSiO_{b} | Si + SiO | CC > CB > CA | 10 | 1.30 | 6 | 5 | 841.7 | 84.0 | 85.1 |
| Example 12 | MgₐSiO_{b} | Si + SiO | CC > CB > CA | 10 | 1.40 | 6 | 5 | 796.5 | 79.7 | 78.7 |

TABLE 2

| | Negative electrode | | | | | | | | | Capacity |
|---|---|---|---|---|---|---|---|---|---|---|
| | active material | | Relationship among | Abundance | | Crystallite | Median | Battery | Initial | retention |
| | Metal | | abundances | rate | Content | size | diameter | capacity | efficiency | rate |
| | silicate | Others | (CA, CB, CC) | (mol %) | ratio | (nm) | (μm) | (mAh/g) | (%) | (%) |
| Example 13 | MgₐSiO_{b} | Si + SiO | CC > CB > CA | 10 | 1.00 | 0 | 5 | 1385.5 | 88.7 | 90.7 |
| Example 14 | MgₐSiO_{b} | Si + SiO | CC > CB > CA | 10 | 1.00 | 8 | 5 | 1407.6 | 86.5 | 87.5 |
| Example 15 | MgₐSiO_{b} | Si + SiO | CC > CB > CA | 10 | 1.00 | 10 | 5 | 1397.7 | 84.9 | 87.1 |
| Example 16 | MgₐSiO_{b} | Si + SiO | CC > CB > CA | 10 | 1.00 | 20 | 5 | 1385.9 | 83.2 | 85.0 |
| Example 17 | MgₐSiO_{b} | Si + SiO | CC > CB > CA | 10 | 1.00 | 30 | 5 | 1364.0 | 81.9 | 84.1 |
| Example 18 | MgₐSiO_{b} | Si + SiO | CC > CB > CA | 10 | 1.00 | 40 | 5 | 1231.6 | 77.0 | 69.1 |
| Example 19 | MgₐSiO_{b} | Si + SiO | CC > CB > CA | 10 | 1.00 | 0 | 5 | 1429.6 | 83.4 | 80.1 |
| Example 20 | MgₐSiO_{b} | Si + SiO | CC > CB > CA | 10 | 1.00 | 6 | 0.1 | 1428.6 | 85.1 | 84.8 |
| Example 21 | MgₐSiO_{b} | Si + SiO | CC > CB > CA | 10 | 1.00 | 6 | 10 | 1428.9 | 85.1 | 87.4 |
| Example 22 | MgₐSiO_{b} | Si + SiO | CC > CB > CA | 10 | 1.00 | 6 | 30 | 1426.3 | 85.9 | 86.8 |
| Example 23 | MgₐSiO_{b} | Si + SiO | CC > CB > CA | 10 | 1.00 | 6 | 50 | 1428.3 | 86.0 | 85.6 |
| Example 24 | MgₐSiO_{b} | Si + SiO | CC > CB > CA | 10 | 1.00 | 6 | 55 | 1271.7 | 85.1 | 77.4 |
| Comparative | — | Si + SiO | — | — | 1.00 | 6 | 5 | 1710.5 | 72.5 | 65.0 |
| example 1 | | | | | | | | | | |
| Comparative | MgₐSiO_{b} | Si + SiO | CC = CB = CA | 10 | 1.00 | 6 | 5 | 1426.3 | 76.9 | 65.0 |
| example 2 | | | | | | | | | | |
| Comparative | MgₐSiO_{b} | Si + SiO | CC > CB = CA = 0 | 10 | 1.00 | 6 | 5 | 1418.3 | 76.5 | 66.1 |
| example 3 | | | | | | | | | | |

As indicated in Tables 1 and 2, each of the battery capacity, the initial efficiency, and the capacity retention rate varied depending on the configuration of the negative electrode active material.

Specifically, when the negative electrode active material included no metal silicate (Comparative example 1), each of the initial efficiency and the capacity retention rate decreased.

When the negative electrode active material included the metal silicate but the abundances CA, CB, and CC did not satisfy the appropriate relationship of CC>CB>CA (Comparative examples 2 and 3), each of the battery capacity, the initial efficiency, and the capacity retention rate decreased.

In contrast, when the negative electrode active material included the metal silicate and the abundances CA, CB, and CC satisfied the appropriate relationship of CC>CB>CA (Examples 1 to 24), each of the battery capacity, the initial efficiency, and the capacity retention rate increased.

In particular, when the abundances CA, CB, and CC satisfied the appropriate relationship, the following tendencies were obtained.

Firstly, when the metal silicate was the first metal silicate, and the first metal silicate included magnesium as an alkaline earth metal element, a high battery capacity, high initial efficiency, and a high capacity retention rate were obtained.

Although experiment results are not described here, a tendency similar to the tendency when the first metal silicate was used was obtained also when the second metal silicate or the third metal silicate was used in place of the first metal silicate.

Secondly, when the abundance rate was within the range from 1 mol % to 20 mol % both inclusive, the capacity retention rate further increased while the battery capacity and the initial efficiency were satisfactory.

Thirdly, when the oxygen-silicon ratio was within the range from 0.80 to 1.30 both inclusive, the capacity retention rate further increased while the battery capacity and the initial efficiency were satisfactory.

Fourthly, when the crystallite size was less than or equal to 30 nm, the capacity retention rate further increased while the battery capacity and the initial efficiency were satisfactory.

Fifthly, when the median diameter was within the range from 0.1 μm to 50 μm both inclusive, the battery capacity, the initial efficiency, and the capacity retention rate further increased.

Sixthly, when the negative electrode active material included the simple substance of silicon and the silicon oxide together with the metal silicate, a high battery capacity, high initial efficiency, and a high capacity retention rate were obtained.

Based upon the results presented in Tables 1 and 2, when: the negative electrode active material 2 included the metal silicate; and the abundances CA, CB, and CC satisfied the appropriate relationship of CC>CB>CA where the section of the negative electrode active material 2 was classified into the center part 2A, the middle part 2B, and the surface part 2C, a high battery capacity, high initial efficiency, and a high capacity retention rate were obtained. Each of the capacity characteristic, the initial charge and discharge characteristic, and the cyclability characteristic therefore improved. Accordingly, it was possible to achieve a superior battery characteristic.

Although the present disclosure has been described above with reference to some example embodiments and Examples, the configuration of any embodiment of the present disclosure is not limited to those described with reference to the example embodiments and Examples above, and is therefore modifiable in a variety of ways.

For example, the description has been given of the case where the secondary battery has a battery structure of the cylindrical type or the coin type. However, the battery structure of the secondary battery is not particularly limited. In an embodiment, the battery structure of the secondary battery may be, for example, of a laminated-film type, a prismatic type, or a button type.

Further, the description has been given of the case where the battery device has a device structure of a wound type. However, the device structure of the battery device is not particularly limited. In an embodiment, the device structure of the battery device may be, for example, of a stacked type or a zigzag folded type. In the stacked type, the positive electrode and the negative electrode may be alternately stacked on each other with the separator interposed therebetween. In the zigzag folded type, the positive electrode and the negative electrode may be opposed to each other with the separator interposed therebetween, and may be folded in a zigzag manner.

Further, although the description has been given of the case where the electrode reactant is lithium, the electrode reactant is not particularly limited. In an embodiment, the electrode reactant may be another alkali metal such as sodium or potassium, or may be an alkaline earth metal such as beryllium, magnesium, or calcium, as described above. In an embodiment, the electrode reactant may be another light metal such as aluminum.

The effects described herein are mere examples, and effects of an embodiment of the present disclosure are therefore not limited to those described herein. Accordingly, an embodiment of the present disclosure may achieve any other effect.

Furthermore, the present disclosure encompasses any possible combination of some or all of the various embodiments and the modification examples described herein and incorporated herein. It is possible to achieve at least the following configurations from the above-described example embodiments of the present disclosure.

(1)

A secondary battery including:
a positive electrode;
a negative electrode including a negative electrode active material into which an electrode reactant is to be inserted and from which the electrode reactant is to be extracted; and
an electrolytic solution, in which
the negative electrode active material includes a metal silicate,
the metal silicate includes a metal element, silicon, and oxygen as constituent elements,
the metal element includes at least one of an alkaline earth metal element, an alkali metal element, a transition metal element, or an amphoteric metal element, other than a constituent element of the electrode reactant,
the negative electrode active material includes a center part, a surface part, and a middle part, the center part including the metal silicate, the surface part being positioned on an outer side of the center part and including the metal silicate, the middle part being positioned between the center part and the surface part and including the metal silicate, and
a ratio among a sectional area of the center part, a sectional area of the middle part, and a sectional area of the surface part in a section of the negative electrode active material is set to 1:3:5 thereby an abundance of the metal element in the middle part is greater than an abundance of the metal element in the center part, and an abundance of the metal element in the surface part is greater than the abundance of the metal element in the middle part.
   (2)

The secondary battery according to (1), in which the metal silicate includes at least one of a first metal silicate represented by Formula (1), a second metal silicate represented by Formula (2), a third metal silicate represented by Formula (3), a fourth metal silicate represented by Formula (4), or a fifth metal silicate represented by Formula (5),

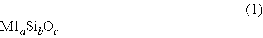

where
M1 is at least one of alkaline earth metal elements,
a satisfies 0<a<4,
b satisfies 0<b<5, and
c satisfies 0<c<7,

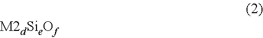

where
M2 is at least one of alkali metal elements,
d satisfies 1<d<7,
e satisfies 0<e<5, and
f satisfies 2<f<10,

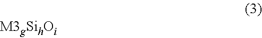

where
M3 is at least one of transition metal elements,
g satisfies 0<g<3,
h satisfies 0<h<2, and
i satisfies 2<i<5,

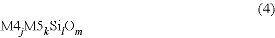

where
M4 is at least one of alkali metal elements,
M5 is at least one of an alkaline earth metal element, a transition metal element, or an amphoteric metal element,
j satisfies 0<j<3,
k satisfies 0<k<3,
l satisfies 0<1<4, and
m satisfies 2<m<7,

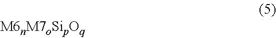

where
M6 is at least one of alkaline earth metal elements,
M7 is at least one of an alkaline earth metal element, a transition metal element, or an amphoteric metal element,
n satisfies 0<n<4,
satisfies 0<o<3,
p satisfies 0<p<4, and
q satisfies 2<q<7.
   (3)

The secondary battery according to (2), in which the metal silicate includes the first metal silicate.

(4)

The secondary battery according to (3), in which the alkaline earth metal element includes magnesium.

(5)

The secondary battery according to any one of (1) to (4), in which a rate of a content of the metal element to a sum of the content of the metal element, a content of silicon, and a content of oxygen in the negative electrode active material is greater than or equal to 1 mole percent and less than or equal to 20 mole percent.

(6)

The secondary battery according to any one of (1) to (5), in which a ratio of a content of oxygen to a content of silicon in the negative electrode active material is greater than or equal to 0.80 and less than or equal to 1.30.

(7)

The secondary battery according to any one of (1) to (6), in which a crystallite size of a silicon (220) crystal plane in the negative electrode active material is less than or equal to 30 nanometers.

(8)

The secondary battery according to any one of (1) to (7), in which the negative electrode includes a plurality of the negative electrode active materials, the negative electrode active materials each having a particle shape, and a median diameter of the negative electrode active materials each having the particle shape is greater than or equal to 0.1 micrometers and less than or equal to 50 micrometers.

(9)

The secondary battery according to any one of (1) to (8), in which the negative electrode active material includes a simple substance of silicon, and a silicon oxide represented by Formula (6)

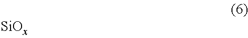

where x satisfies 0<x≤2.

(10)

The secondary battery according to (9), in which x in Formula (6) satisfies 0.5≤x≤1.5.

(11)

The secondary battery according to any one of (1) to (10), in which
the negative electrode further includes a film provided on a surface of the negative electrode active material, and
the film includes a carbon material.
   (12)

The secondary battery according to any one of (1) to (11), in which the secondary battery includes a lithium secondary battery.

(13)

A negative electrode for a secondary battery, the negative electrode including:
a negative electrode active material into which an electrode reactant is to be inserted and from which the electrode reactant is to be extracted, in which
the negative electrode active material includes a metal silicate,
the metal silicate includes a metal element, silicon, and oxygen as constituent elements,
the metal element includes at least one of an alkaline earth metal element, an alkali metal element, a transition metal element, or an amphoteric metal element, other than a constituent element of the electrode reactant,
the negative electrode active material includes a center part, a surface part, and a middle part, the center part including the metal silicate, the surface part being positioned on an outer side of the center part and including the metal silicate, the middle part being positioned between the center part and the surface part and including the metal silicate, and
a ratio among a sectional area of the center part, a sectional area of the middle part, and a sectional area of the surface part in a section of the negative electrode active material is set to 1:3:5 thereby an abundance of the metal element in the middle part is greater than an abundance of the metal element in the center part, and an abundance of the metal element in the surface part is greater than the abundance of the metal element in the middle part.

According to a negative electrode for a secondary battery of at least an embodiment of the present disclosure or a secondary battery of at least an embodiment of the present disclosure, a negative electrode active material includes a metal silicate, and when a section of the negative electrode active material is classified into a center part, a middle part, and a surface part, abundances of the metal element in the center part, the middle part, and the surface part of the negative electrode active material satisfy the following relationship: abundance of metal element in surface part>abundance of metal element in middle part>abundance of metal element in center part. This helps to obtain a superior battery characteristic.

Note that effects of an embodiment of the present disclosure are not necessarily limited to the example effects described above and may include any of a series of effects described herein in relation to the example embodiments of the present disclosure.

Although the present disclosure has been described hereinabove in terms of the example embodiment and modification examples, the present disclosure is not limited thereto. It should be appreciated that variations may be made in the described example embodiment and modification examples by those skilled in the art without departing from the scope of the present disclosure as defined by the following claims. The limitations in the claims are to be interpreted broadly based on the language employed in the claims and not limited to examples described in this specification or during the prosecution of the application, and the examples are to be construed as non-exclusive. As used in this specification and the appended claims, the singular forms “a,” “an,” and “the” include, especially in the context of the claims, are to be construed to cover both the singular and the plural, unless otherwise indicated herein or clearly contradicted by context. Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step. The use of the terms first, second, etc. do not denote any order or importance, but rather the terms first, second, etc. are used to distinguish one element from another. The term “substantially”, “approximately”, “about”, and its variants having the similar meaning thereto are defined as being largely but not necessarily wholly what is specified as understood by one of ordinary skill in the art. The term “disposed on/provided on/formed on” and its variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode including a negative electrode active material into which an electrode reactant is to be inserted and from which the electrode reactant is to be extracted; and
an electrolytic solution, wherein
the negative electrode active material includes a metal silicate,
the metal silicate includes a metal element, silicon, and oxygen as constituent elements,
the metal element includes at least one of an alkaline earth metal element, an alkali metal element, a transition metal element, or an amphoteric metal element, other than a constituent element of the electrode reactant,
the negative electrode active material includes a center part, a surface part, and a middle part, the center part including the metal silicate, the surface part being positioned on an outer side of the center part and including the metal silicate, the middle part being positioned between the center part and the surface part and including the metal silicate, and
a ratio among a sectional area of the center part, a sectional area of the middle part, and a sectional area of the surface part in a section of the negative electrode active material is set to 1:3:5 thereby an abundance of the metal element in the middle part is greater than an abundance of the metal element in the center part, and an abundance of the metal element in the surface part is greater than the abundance of the metal element in the middle part.

2. The secondary battery according to claim 1, wherein the metal silicate includes at least one of a first metal silicate represented by Formula (1), a second metal silicate represented by Formula (2), a third metal silicate represented by Formula (3), a fourth metal silicate represented by Formula (4), or a fifth metal silicate represented by Formula (5), 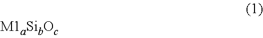
where
M1 is at least one of alkaline earth metal elements,
a satisfies 0<a<4,
b satisfies 0<b<5, and
c satisfies 0<c<7, 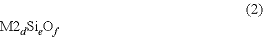
where
M2 is at least one of alkali metal elements,
d satisfies 1<d<7,
e satisfies 0<e<5, and
f satisfies 2<f<10, 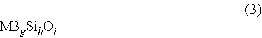
where
M3 is at least one of transition metal elements,
g satisfies 0<g<3,
h satisfies 0<h<2, and
i satisfies 2<i<5, 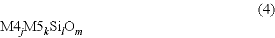
where
M4 is at least one of alkali metal elements,
M5 is at least one of an alkaline earth metal element, a transition metal element, or an amphoteric metal element,
j satisfies 0<j<3,
k satisfies 0<k<3,
l satisfies 0<1<4, and
m satisfies 2<m<7, 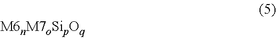
where
M6 is at least one of alkaline earth metal elements,
M7 is at least one of an alkaline earth metal element, a transition metal element, or an amphoteric metal element,
n satisfies 0<n<4,
o satisfies 0<o<3,
p satisfies 0<p<4, and
q satisfies 2<q<7.

3. The secondary battery according to claim 2, wherein the metal silicate includes the first metal silicate.

4. The secondary battery according to claim 3, wherein the alkaline earth metal element includes magnesium.

5. The secondary battery according to claim 1, wherein a rate of a content of the metal element to a sum of the content of the metal element, a content of silicon, and a content of oxygen in the negative electrode active material is greater than or equal to 1 mole percent and less than or equal to 20 mole percent.

6. The secondary battery according to claim 1, wherein a ratio of a content of oxygen to a content of silicon in the negative electrode active material is greater than or equal to 0.80 and less than or equal to 1.30.

7. The secondary battery according to claim 1, wherein a crystallite size of a silicon (220) crystal plane in the negative electrode active material is less than or equal to 30 nanometers.

8. The secondary battery according to claim 1, wherein
the negative electrode includes a plurality of the negative electrode active materials, the negative electrode active materials each having a particle shape, and
a median diameter of the negative electrode active materials each having the particle shape is greater than or equal to 0.1 micrometers and less than or equal to 50 micrometers.

9. The secondary battery according to claim 1, wherein the negative electrode active material includes a simple substance of silicon, and a silicon oxide represented by Formula (6), 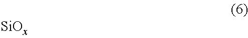
where x satisfies 0<x≤2.

10. The secondary battery according to claim 9, wherein x in Formula (6) satisfies 0.5≤x≤1.5.

11. The secondary battery according to claim 1, wherein
the negative electrode further includes a film provided on a surface of the negative electrode active material, and
the film includes a carbon material.

12. The secondary battery according to claim 1, wherein the secondary battery comprises a lithium secondary battery.

13. A negative electrode for a secondary battery, the negative electrode comprising:
a negative electrode active material into which an electrode reactant is to be inserted and from which the electrode reactant is to be extracted, wherein
the negative electrode active material includes a metal silicate,
the metal silicate includes a metal element, silicon, and oxygen as constituent elements,
the metal element includes at least one of an alkaline earth metal element, an alkali metal element, a transition metal element, or an amphoteric metal element, other than a constituent element of the electrode reactant,
the negative electrode active material includes a center part, a surface part, and a middle part, the center part including the metal silicate, the surface part being positioned on an outer side of the center part and including the metal silicate, the middle part being positioned between the center part and the surface part and including the metal silicate, and
a ratio among a sectional area of the center part, a sectional area of the middle part, and a sectional area of the surface part in a section of the negative electrode active material is set to 1:3:5 thereby an abundance of the metal element in the middle part is greater than an abundance of the metal element in the center part, and an abundance of the metal element in the surface part is greater than the abundance of the metal element in the middle part.
